(19) United States
(12) Patent Application Publication
(10) Pub. No.: US 2021/0061827 A1
(43) Pub. Date: Mar. 4, 2021

(54) Silicon Compound Containing Hexafluoroisopropanol Group, and Method for Producing Same

(71) Applicant: Central Glass Company, Limited, Ube-shi, Yamaguchi (JP)

(72) Inventors: Junya NAKATSUJI, Fujimino-shi, Saitama (JP); Tomohiro KATAMURA, Fujimino-shi, Saitama (JP); Yutaka SUGITA, Fujimino-shi, Saitama (JP); Kazuhiro YAMANAKA, Tachikawa-shi, Tokyo (JP)

(21) Appl. No.: 16/970,286

(22) PCT Filed: Feb. 21, 2019
(86) PCT No.: PCT/JP2019/006429

§ 371 Date: Aug. 14, 2020

(30) Foreign Application Priority Data
Feb. 28, 2018 (JP) 2018-035470

(51) Int. Cl. C07F 7/12; C08G 77/24

(52) U.S. Cl. CPC C07F 7/12; C07F 7/127; C08G 77/24

(57) ABSTRACT

Provided is a production method for producing an aromatic alkoxysilane containing a hexafluoropropanol group (—C(CF₃)₂OH; referred to as HFIP group) from an inexpensive starting raw material with a high reaction conversion rate and selectivity. As shown in the following scheme, the production method includes: a first step of reacting an aromatic halosilane with hexafluoroacetone in the presence of a Lewis acid catalyst, thereby obtaining a HFIP group-containing aromatic halosilane; and a second step of forming the HFIP group-containing aromatic alkoxysilane by reacting the HFIP group-containing aromatic halosilane with an alcohol.

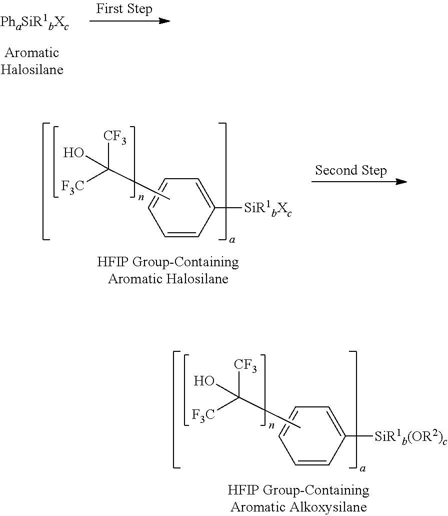

### FIELD OF THE INVENTION

The present invention relates to a hexafluoroisopropanol group-containing silicon compound and a production method thereof.

### BACKGROUND ART

Polymers with siloxane bonds (hereinafter also referred to as polysiloxane polymers) are used as coating materials and sealing materials in the field of semiconductors by taking advantage of their high heat resistance, transparency etc. The polysiloxane polymers are also used as resist layer materials because of their high resistance to oxygen plasma.

In the case of using a polysiloxane polymer as a resist material, it is required that the polysiloxane polymer is soluble in an alkali such as alkaline developer. As a technique to make the polysiloxane polymer soluble in an alkaline developer, it is conceivable to introduce an acidic group into the polysiloxane polymer. As such an acidic group, there can be used a phenol group, a carboxyl group, a fluorocarbinol group or the like.

For example, Patent Document 1 discloses a polysiloxane polymer having introduced thereinto a phenol group. Patent Document 2 discloses a polysiloxane polymer having introduced thereinto a carboxyl group. These polysiloxane polymers are alkali-soluble resins, and can be used in combination with photosensitive compounds having quinone diazide groups etc. as positive resist compositions. On the other hand, it is known that a polysiloxane polymer having a phenol group or carboxyl group may cause transparency deterioration or coloring during use under high-temperature conditions or may be poor in heat resistance.

Patent Documents 3 and 4 each disclose a polysiloxane polymer having introduced thereinto an acidic fluorocarbinol group such as hexafluoroisopropanol group (2-hydroxy-1,1,1,3,3,3-hexafluoroisopropyl group (—C(CF₃)₂OH); hereinafter also referred to as HFIP group).

More specifically, Patent Document 3 discloses a method of producing a HFIP group-containing organic silicon compound (R₃Si—CH₂—CH₂—CH₂—C(CF₃)₂OH where R₃ is a C₁-C₃ alkoxy group) by hydrosilylation of a HFIP group-containing compound represented by CH₂═CH—CH₂—C(CF₃)₂OH with a trialkoxysilane having a C₁-C₃ alkoxy group.

Patent Document 4 discloses a polymer compound having a main chain consisting only of siloxane units and containing a fluorocarbinol group bonded to the main chain via a C₁-C₂₀ linear, branched, cyclic or bridged cyclic divalent hydrocarbon group.

The organic silicon compound of Patent Document 3 has a structure in which a propylene bond (—CH₂—CH₂—CH₂—) is present between a HFIP group and a silicon atom (Si). The polymer compound of Patent Document 4 has a structure in which an aliphatic hydrocarbon group is present between a HFIP group and a silicon atom of the main chain.

By contrast, Patent Documents 5 and 6 each disclose a HFIP group-containing polysiloxane polymer (A) having a siloxane main chain with a repeating unit of the following formula in which an aromatic ring is present between a HFIP group and a silicon atom of the siloxane main chain. It is described in these patent documents that the disclosed HFIP group-containing polysiloxane polymer shows much higher heat resistance than that of the polymer compounds of Patent Documents 2 and 3.

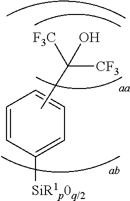

In the formula, R¹ is a hydrocarbon group in which a hydrogen atom(s) may be substituted with a fluorine atom; aa is an integer of 1 to 5; ab is an integer of 1 to 3; p is an integer of 0 to 2; q is an integer of 1 to 3; and a relationship of ab+p+q=4 is satisfied.

It is also described in these patent documents that the disclosed HFIP group-containing polysiloxane polymer combines transparency with alkali solubility.

Further, Patent Document 5 discloses a method of synthesizing a HFIP group-containing silicon compound (D) by using a HFIP group-containing aromatic halogen compound (B) and a hydrosilyl (Si—H) group-containing compound (C) as raw material compounds and reacting the raw material compounds in the presence of bis(acetonitrile)(1,5-cyclooctadiene)rhodium (I) tetrafluoroborate as a catalyst as shown in the following scheme.

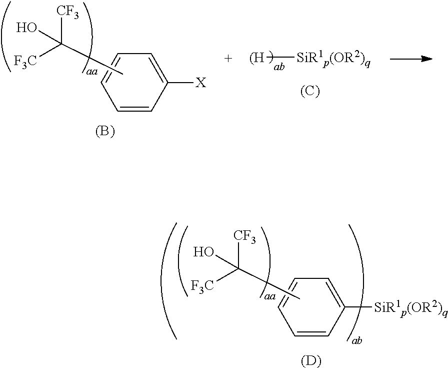

In the scheme, the definitions of R¹, aa, ab, p and q are the same as above; X is a halogen atom; and R² is an alkyl group.

The above-mentioned HFIP group-containing polysiloxane polymer (A) is obtained by hydrolysis and polycondensation of the HFIP group-containing silicon compound (D).

Furthermore, Patent Document 6 discloses a positive photosensitive resin composition including the HFIP group-containing polysiloxane polymer (A), an photoacid generator or quinone diazide compound and a solvent.

Non-Patent Document 1 discloses, as a technique to form an aromatic silicon compound by directly bonding a silyl group to an aromatic ring, not only a method of reacting an aromatic halogen compound with a hydrosilyl group-containing compound as described in Patent Document 5, but also a method of directly reacting an aromatic halogen compound with a metal silicon and a method using a Grignard reaction. Among these, the method of directly reacting the aromatic halogen compound with the metal silicon and the method using the Grignard reaction are useful, but are difficult to apply to the production of an aromatic silicon compound having a substituent group such as HFIP group which is likely to cause a side reaction.

Non-Patent Document 2 discloses a method of directly introducing a HFIP group into an aromatic compound by aromatic electrophilic substitution with a hexafluoroacetone (hereinafter also referred to as HFA) gas through the use of a Lewis acid. On the other hand, it is known that a Ph-Si bond (i.e. a direct bond between a phenyl group and a Si atom; the same applies to the following) is easily cleaved in the presence of aluminum chloride or an acid (such as hydrochloric acid or sulfuric acid) (see Non-Patent Documents 3 and 4).

### PRIOR ART DOCUMENTS

### Patent Documents

Patent Document 1: Japanese Laid-Open Patent Publication No. H4-130324

Patent Document 2: Japanese Laid-Open Patent Publication No. 2009-286980

Patent Document 3: Japanese Laid-Open Patent Publication No. 2004-256503

Patent Document 4: Japanese Laid-Open Patent Publication No. 2002-55456

Patent Document 5: Japanese Laid-Open Patent Publication No. 2014-156461

Patent Document 6: Japanese Laid-Open Patent Publication No. 2015-129908

### Non-Patent Documents

Non-Patent Document 1: Journal of Synthetic Organic Chemistry, Japan, 2009, vol. 67, no. 8, p. 778-786

Non-Patent Document 2: Journal of Organic Chemistry, 1965, 30, p. 998-1001

Non-Patent Document 3: Kunio ITO, “Silicone Handbook”, Nikkan Kogyo Shinbunsha, Aug. 31, 1998, p. 104

Non-Patent Document 4: Journal of American Chemical Society, 2002, 124, p. 1574-1575

### SUMMARY OF THE INVENTION

### Problems to be Solved by the Invention

As mentioned above, the synthesis method of Patent Document 5 is particularly useful to produce the HFIP group-containing silicon compound (D) and the HFIP group-containing polysiloxane polymer (A) as a derivative of the HFIP group-containing silicon compound. In particular, it can be said that the synthesis method of Patent Document 5 is superior in that the HFIP group-containing silicon compound (D) can be synthesized through one-step reaction under moderate conditions by using the HFIP group-containing aromatic halogen compound (B) and the hydrosilyl compound (C) as the raw material compounds.

It has however been found as a result of researches made by the present inventors that this synthesis method tends to, during the reaction, cause a side reaction such as further reaction of the target compound (D) and the hydrosilyl compound (C), reduction reaction of the aromatic halogen compound as disclosed in Non-Patent Document 1 etc., whereby it is difficult to improve the yield of the target compound (D) (see e.g. Comparative Example 3 of the present specification). Accordingly, there is still room for improvement in the synthesis method of Patent Document 5.

### Means for Solving the Problems

The present inventors have made extensive researches to solve the above-mentioned problems and resultantly found a method of producing a HFIP group-containing silicon compound (D) (hereinafter also referred to as a “silicon compound of the formula (4)” or a “HFIP group-containing aromatic alkoxysilane”) through the following first and second steps.

The first step is a step of reacting an aromatic silicon compound of the formula (1) (hereinafter also referred to as an “aromatic halosilane”) with HFA in the presence of a Lewis acid catalyst such as aluminum chloride, thereby obtaining a silicon compound of the formula (2) (hereinafter also referred to as a “HFIP-containing aromatic halosilane”).

The second step is a step of forming the silicon compound of the formula (4) by reacting the silicon compound of the formula (2) obtained in the first step with an alcohol of the formula (3).

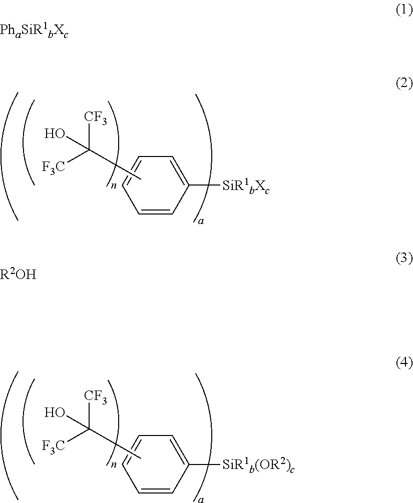

The definitions of respective symbols in the formulas (1) to (4) for the compounds of the first and second steps are as follows: Ph is an unsubstituted phenyl group; R¹ is each independently a C₁-C₁₀ linear, C₃-C₁₀ branched or C₃-C₁₀ cyclic alkyl group, or a C₂-C₁₀ linear, C₃-C₁₀ branched or C₃-C₁₀ cyclic alkenyl group; a part or all of hydrogen atoms of the alkyl group or alkenyl group as R¹ may be substituted with a fluorine atom; X is a halogen atom; a is an integer of 1 to 3; b is an integer of 0 to 2; c is an integer of 1 to 3; a relationship of a+b+c=4 is satisfied; n is an integer of 1 to 5; R² is each independently a C₁-C₄ linear or C₃-C₄ branched alkyl group; and a part or all of hydrogen atoms of the alkyl group as R² may be substituted with a fluorine atom.

As mentioned above, Non-Patent Document 3 discloses that a Ph-Si bond is particularly likely to be cleaved in the presence of aluminum chloride or a strong acid (such as hydrochloric acid or sulfuric acid); and Non-Patent Document 4 discloses a practical example of synthesis of a ladder siloxane by clearage of a Ph-Si bond. The present inventors initially expected from such disclosures that, in the first step, the cleavage of a Ph-Si bond would proceed preferentially upon contact of the aromatic halosilane (1) with the Lewis acid catalyst such as aluminum chloride.

Contrary to this expectation, the present inventors have found that the reaction of the first step proceeds smoothly by contact of the aromatic halosilane (1) with the HFA in the presence of the Lewis acid catalyst such as aluminum chloride whereby the HFIP group-containing aromatic halosilane (2) can be obtained with a high yield. As is apparent from the after-mentioned Examples 1 to 3, the reaction of the first step is surprisingly high in reaction conversion rate and selectivity and high in efficiency. (See Examples 1 to 3 of the present specification.)

The thus-obtained HFIP-containing aromatic halosilane (2) is a novel compound.

The present inventors have also found that, when the above-obtained HFIP group-containing aromatic halosilane (2) is subjected to the second step, the reaction of the second step proceeds efficiently whereby the HFIP group-containing aromatic alkoxysilane (4) can be obtained with a high yield (see Examples 4 to 7 of the present specification).

Although the production method of the HFIP group-containing aromatic alkoxysilane (4) according to the present invention requires the two first and second steps, the total yield through these two steps (see Examples 1 to 7 of the present specification) is significantly high as compared to that of the synthesis method (single reaction step) of Patent Document 5 (see Comparative Example 3 of the present specification). Thus, the production method according to the present invention is superior for production of the HFIP group-containing aromatic alkoxysilane (4).

In addition, the production method according to the present invention is advantageous in terms of the cost in view of the fact that, although the raw starting material (B) used in Comparative Example 3 of the present specification is industrially available but is relatively expensive, the aromatic halosilane (1) and HFA used as the raw starting materials in the first step of the present invention are available at relatively low costs. As a silane compound similarly available at a low cost, an alkoxysilane is known. When the alkoxysilane is reacted with HFA, however, the reaction readily occurs on an alkoxysilyl side of the alkoxysilane so that the HFIP group-containing aromatic alkoxysilane (4) cannot be obtained as shown in the following scheme (see “Inorganic Chemistry”, 1966, 5, p. 1831-1832 and Comparative Examples 1 and 2 of the present specification).

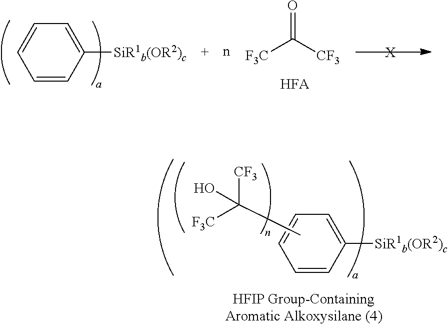

In the scheme, the definitions of R¹, R², a, b, c and n are the same as above.

A HFIP group-containing polysiloxane polymer (A) is derived by hydrolysis and polycondensation (third step) of the HFIP group-containing aromatic alkoxysilane (4) obtained in the second step, as in the conventional synthesis method (Patent Document 5). In the case where the HFIP group-containing aromatic alkoxysilane (4) is produced by the first and second steps of the present invention, the total production yield of the HFIP group-containing polysiloxane polymer (A) becomes high by combination of the third step with the first and second steps due to the high-yield production of the HFIP group-containing aromatic halosilane (2). Therefore, the present invention allows especially advantageous production of the HFIP group-containing polysiloxane polymer (A).

The present inventors have further found that: the HFIP group-containing aromatic halosilane (2) itself, which is also a novel compound found during the progress of the present invention, has the property of undergoing hydrolysis and polycondensation; and thus, the HFIP group-containing polysiloxane polymer (A) can be directly produced by hydrolysis and polycondensation (fourth step) of the HFIP group-containing aromatic halosilane (2) (without going through the HFIP group-containing aromatic alkoxysilane (4)). In other words, the HFIP group-containing polysiloxane polymer (A) can be obtained in two reaction steps, i.e., by obtaining the HFIP group-containing aromatic halosilane (2) in the first step and subjecting the thus-obtained HFIP group-containing aromatic halosilane (2) as it is to the fourth step. It is feasible for a person skilled in the art to appropriately determine whether to produce the HFIP group-containing polysiloxane polymer (A) through the three first, second and third steps or through the two first and fourth steps.

In this way, the present inventors have found out the characteristic “reaction of the first step” and the “HFIP group-containing aromatic halosilane (2) (novel compound)” as the product of the reaction of the first step. The present invention has been established based on these findings.

For reference purposes, the names of the compounds and process steps relevant to the present invention are summarized below.

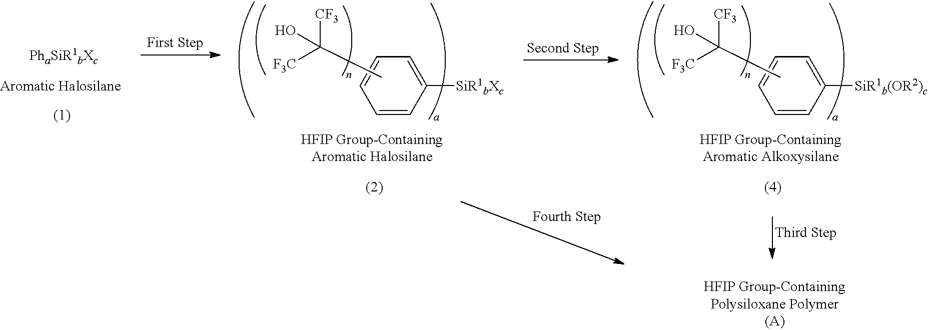

Since respective one of the compounds is occasionally called by another name in the present application, a correlation of the compound names is shown in TABLE 1.

TABLE 1

| Name of compound | Another name used in specification etc. |
|---|---|
| Aromatic silicon compound of formula (1) | Aromatic halosilane (1) |
| Silicon compound of formula (2) | HFIP group-containing aromatic halosilane (2) |
| Silicon compound of formula (4) | HFIP group-containing aromatic alkoxysilane (4) |
| Polysiloxane polymer compound (A) with | HFIP group-containing polysiloxane polymer |
| repeating unit of formula (5) | compound (A) |

More specifically, the present invention includes the following inventive aspects 1 to 21.

[Inventive Aspect 1]

A silicon compound of the formula (2)

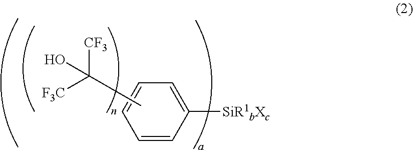

where R¹ is each independently a C₁-C₁₀ linear or C₃-C₁₀ branched or cyclic alkyl group, or a C₂-C₁₀ linear or C₃-C₁₀ branched or cyclic alkenyl group; a part or all of hydrogen atoms of the alkyl group or alkenyl group as R¹ may be substituted with a fluorine atom; X is a halogen atom; a is an integer of 1 to 3; b is an integer of 0 to 2; c is an integer of 1 to 3; a relationship of a+b+c=4 is satisfied; and n is an integer of 1 to 5.

[Inventive Aspect 2]

The silicon compound according to Inventive Aspect 1, wherein the following group (2_{HFIP}) in the formula (2) is any of those represented by the formulas (2A) to (2D)

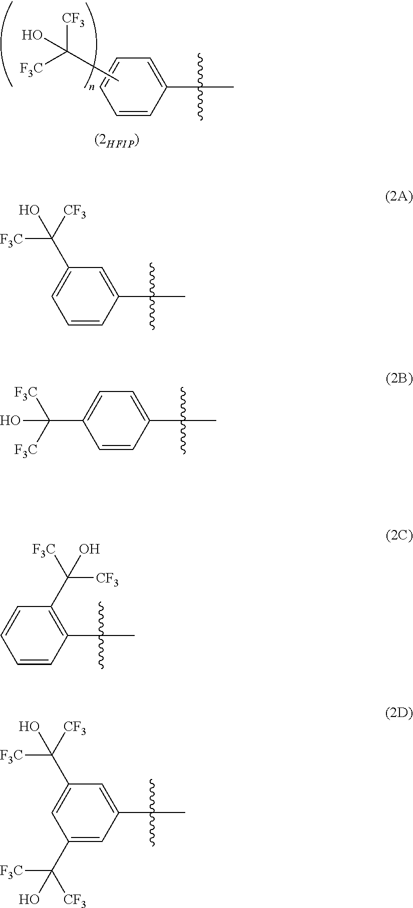

where each wavy line represents that a line which the wavy line intersects is a bond.

[Inventive Aspect 3]

The silicon compound according to Inventive Aspect 1 or 2, wherein X is a chlorine atom.

[Inventive Aspect 4]

The silicon compound according to any one of Inventive Aspects 1 to 3, wherein b is 0 or 1.

[Inventive Aspect 5]

The silicon compound according to any one of Inventive Aspects 1 to 4, wherein R¹ is a methyl group.

[Inventive Aspect 6]

A production method of a silicon compound of the formula (2), comprising the following step: a first step of reacting an aromatic silicon compound of the formula (1) with hexafluoroacetone in the presence of a Lewis acid catalyst, thereby obtaining the silicon compound of the formula (2)

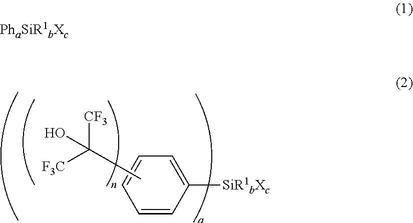

where Ph is an unsubstituted phenyl group; R¹ is each independently a C₁-C₁₀ linear, C₃-C₁₀ branched or C₃-C₁₀ cyclic alkyl group, or a C₂-C₁₀ linear, C₃-C₁₀ branched or C₃-C₁₀ cyclic alkenyl group; a part or all of hydrogen atoms of the alkyl group or alkenyl group as R¹ may be substituted with a fluorine atom; X is a halogen atom; a is an integer of 1 to 3; b is an integer of 0 to 2; c is an integer of 1 to 3; a relationship of a+b+c=4 is satisfied; and n is an integer of 1 to 5.

[Inventive Aspect 7]

A production method of a silicon compound of the formula (4), comprising the following steps:

a first step of reacting an aromatic silicon compound of the formula (1) with hexafluoroacetone in the presence of a Lewis acid catalyst, thereby obtaining a silicon compound of the formula (2); and

a second step of forming the silicon compound of the formula (4) by reacting the silicon compound of the formula (2) obtained in the first step with an alcohol of the formula (3)

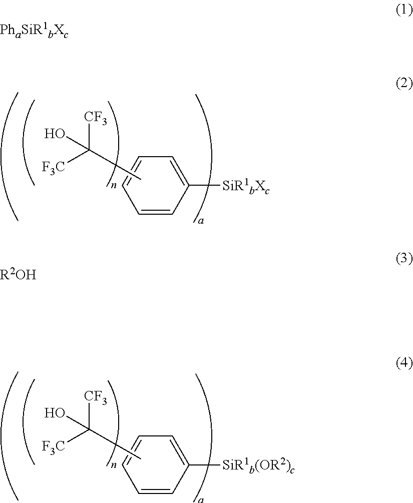

where Ph is an unsubstituted phenyl group; R¹ is each independently a C₁-C₁₀ linear, C₃-C₁₀ branched or C₃-C₁₀ cyclic alkyl group, or a C₂-C₁₀ linear, C₃-C₁₀ branched or C₃-C₁₀ cyclic alkenyl group; a part or all of hydrogen atoms of the alkyl group or alkenyl group as R¹ may be substituted with a fluorine atom; X is a halogen atom; a is an integer of 1 to 3; b is an integer of 0 to 2; c is an integer of 1 to 3; a relationship of a+b+c=4 is satisfied; n is an integer of 1 to 5; R² is each independently a C₁-C₄ linear or C₃-C₄ branched alkyl group; and a part or all of hydrogen atoms of the alkyl group as R² may be substituted with a fluorine atom.

[Inventive Aspect 8]

The production method according to Inventive Aspect 7, wherein the following group (2_{HFIP}) in the formulas (2) and (4) is any of those represented by the formulas (2A) to (2D)

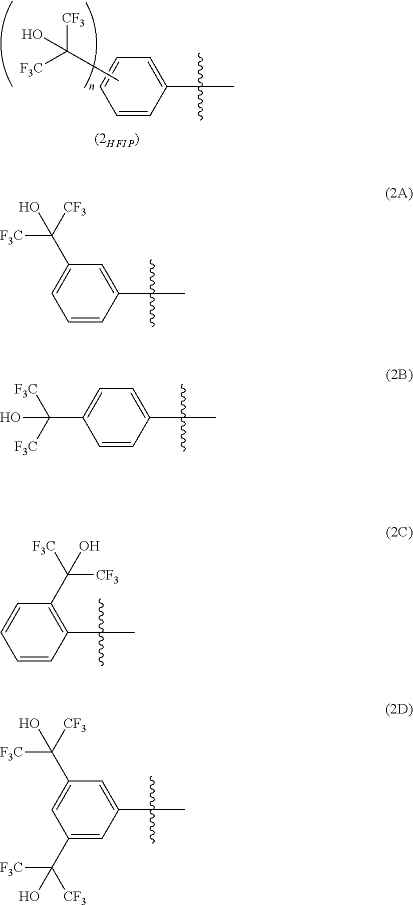

where each wavy line represents that a line which the wavy line intersects is a bond.

[Inventive Aspect 9]

The production method according to Inventive Aspect 7 or 8, wherein X is a chlorine atom.

[Inventive Aspect 10]

The production method according to any one of Inventive Aspects 7 to 9, wherein R² is a methyl group or an ethyl group.

[Inventive Aspect 11]

The production method according to any one of Inventive Aspects 7 to 10, wherein b is 0 or 1.

[Inventive Aspect 12]

The production method according to any one of Inventive Aspects 7 to 11, wherein R¹ is a methyl group.

[Inventive Aspect 13]

The production method according to any one of Inventive Aspects 7 to 12, wherein the Lewis acid catalyst used in the first step is selected from the group consisting of aluminum chloride, iron (III) chloride and boron trifluoride.

[Inventive Aspect 14]

The production method according to any one of Inventive Aspects 7 to 13,

wherein X is a chlorine atom,

wherein R² is a methyl group or an ethyl group,

wherein b is 0 or 1, and

wherein the Lewis acid catalyst used in the first step is selected from the group consisting of aluminum chloride, iron (III) chloride and boron trifluoride.

[Inventive Aspect 15]

The production method according to any one of Inventive Aspects 7 to 14, wherein, in the second step, the reaction is performed with the addition of a hydrogen halide scavenger.

[Inventive Aspect 16]

The production method according to Inventive Aspect 15, wherein the hydrogen halide scavenger is selected from the group consisting of orthoesters and sodium alkoxides.

[Inventive Aspect 17]

A production method of a silicon compound of the formula (4), comprising the following step: a second step of reacting a silicon compound of the formula (2) with an alcohol of the formula (3), thereby forming the silicon compound of the formula (4)

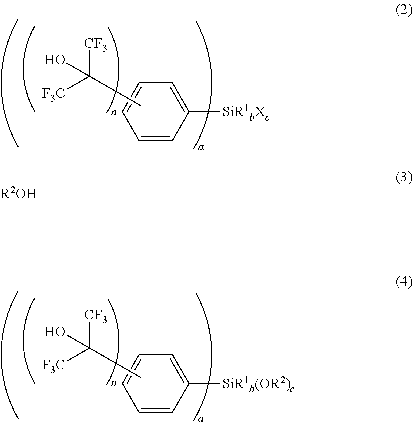

where R¹ is each independently a C₁-C₁₀ linear, C₃-C₁₀ branched or C₃-C₁₀ cyclic alkyl group, or a C₂-C₁₀ linear, C₃-C₁₀ branched or C₃-C₁₀ cyclic alkenyl group; a part or all of hydrogen atoms of the alkyl group or alkenyl group as R¹ may be substituted with a fluorine atom; X is a halogen atom; a is an integer of 1 to 3; b is an integer of 0 to 2; c is an integer of 1 to 3; a relationship of a+b+c=4 is satisfied; n is an integer of 1 to 5; R² is each independently a C₁-C₄ linear or C₃-C₄ branched alkyl group; and a part or all of hydrogen atoms of the alkyl group as R² may be substituted with a fluorine atom.

[Inventive Aspect 18]

The production method according to Inventive Aspect 17, wherein, in the second step, the reaction is performed with the addition of a hydrogen halide scavenger.

[Inventive Aspect 19]

The production method according to Inventive Aspect 18, wherein the hydrogen halide scavenger is selected from the group consisting of orthoesters and sodium alkoxides.

[Inventive Aspect 20]

A production method of a polysiloxane polymer (A) with a repeating unit of the formula (5), comprising the following step after forming the silicon compound of the formula (4) by the production method according to Inventive Aspect 7:

a third step of subjecting the silicon compound of the formula (4) to hydrolysis and polycondensation, thereby obtaining the polysiloxane polymer (A)

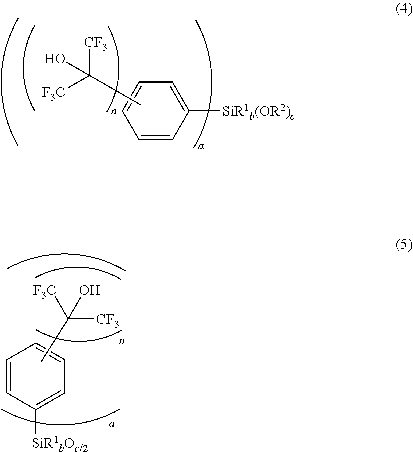

where R¹ is each independently a C₁-C₁₀ linear, C₃-C₁₀ branched or C₃-C₁₀ cyclic alkyl group, or a C₂-C₁₀ linear, C₃-C₁₀ branched or C₃-C₁₀ cyclic alkenyl group; a part or all of hydrogen atoms of the alkyl group or alkenyl group as R¹ may be substituted with a fluorine atom; a is an integer of 1 to 3; b is an integer of 0 to 2; c is an integer of 1 to 3; a relationship of a+b+c=4 is satisfied; n is an integer of 1 to 5; R² is each independently a C₁-C₄ linear or C₃-C₄ branched alkyl group; and a part or all of hydrogen atoms of the alkyl group as R² may be substituted with a fluorine atom.

[Inventive Aspect 21]

A production method of a polysiloxane polymer (A) with a repeating unit of the formula (5), comprising the following step: a fourth step of subjecting a silicon compound of the formula [2] to hydrolysis and polycondensation, thereby obtaining the polysiloxane polymer (A)

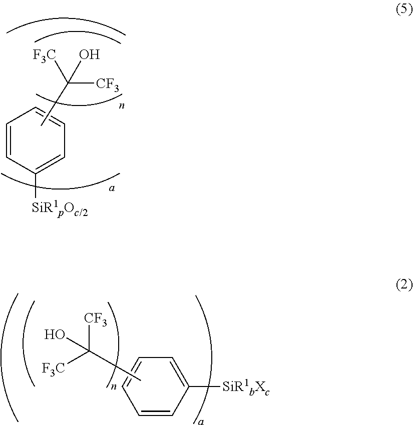

where R¹ is each independently a C₁-C₁₀ linear, C₃-C₁₀ branched or C₃-C₁₀ cyclic alkyl group, or a C₂-C₁₀ linear, C₃-C₁₀ branched or C₃-C₁₀ cyclic alkenyl group; a part or all of hydrogen atoms of the alkyl group or alkenyl group as R¹ may be substituted with a fluorine atom; X is a halogen atom; a is an integer of 1 to 3; b is an integer of 0 to 2; c is an integer of 1 to 3; a relationship of a+b+c=4 is satisfied; n is an integer of 1 to 5; R² is each independently a C₁-C₄ linear or C₃-C₄ branched alkyl group; and a part or all of hydrogen atoms of the alkyl group as R² may be substituted with a fluorine atom.

### Effects of the Invention

According to one aspect of the present invention, the HFIP-containing aromatic halosilane (2), which is a novel compound, is provided.

According to another aspect of the present invention, the HFIP-containing aromatic halosilane (2) is produced with a surprisingly high reaction conversion rate and selectivity using the aromatic halosilane (1) as a starting material (relatively inexpensive raw material) (see the first step).

According to still another aspect of the present invention, the HFIP-containing aromatic alkoxysilane (4) is produced with a high reaction conversion rate and selectivity using the aromatic halosilane (1) as a starting material (see the first and second steps).

According to yet another aspect of the present invention, the HFIP-containing aromatic alkoxysilane (4) is produced using the HFIP-containing aromatic halosilane (2) as a starting material (see the second step).

According to still yet another aspect of the present invention, the HFIP-containing polysiloxane polymer (A) is produced with a comprehensively high yield through the first to third steps using the aromatic halosilane (1) as a starting material.

According to still further another aspect of the present invention, the HFIP-containing polysiloxane polymer (A) is produced with a comprehensively high yield through the fourth step using the aromatic halosilane (2) as a starting material.

### DETAILED DESCRIPTION OF THE EMBODIMENTS

1. Summary of Reaction Process

In the present specification, there are provided two reaction paths (i.e. a reaction path of “the first step+the second step+the third step” and a reaction path of “the first step+the fourth step”), each of which goes through the HFIP group-containing aromatic halosilane (2), as the method for production of the HFIP group-containing polysiloxane polymer (A) as shown in the following scheme. Both of the two reaction paths have a merit that the first step is high in reaction yield and thus are superior as the method for production of the HFIP group-containing polysiloxane polymer (A). The former reaction path is a three-step reaction process, whereas the latter reaction path is a two-step reaction process. It can be thus said that the latter reaction path is more advantageous from the viewpoint of the number of process steps. In some cases, however, the three-step reaction process with “the first step+the second step+the third step” is more advantageous because the HFIP group-containing aromatic alkoxysilane (4) obtained in the second step is high in storage stability and easy to handle. A person skilled in the art can select which reaction path to take depending on the production method and use of the HFIP group-containing polysiloxane polymer (A).

Depending on the economic efficiency and use of the HFIP group-containing polysiloxane polymer (A), a person skilled in the art may select to take both of the two reaction paths (“the first step+the second step+the third step” and “the first step+the fourth step”), that is, to produce the HFIP group-containing polysiloxane polymer (A) by mixing the HFIP group-containing aromatic halosilane (2) and the HFIP group-containing aromatic alkoxysilane (4) at an arbitrary ratio and subjecting the resulting mixed material to hydrolysis and polycondensation.

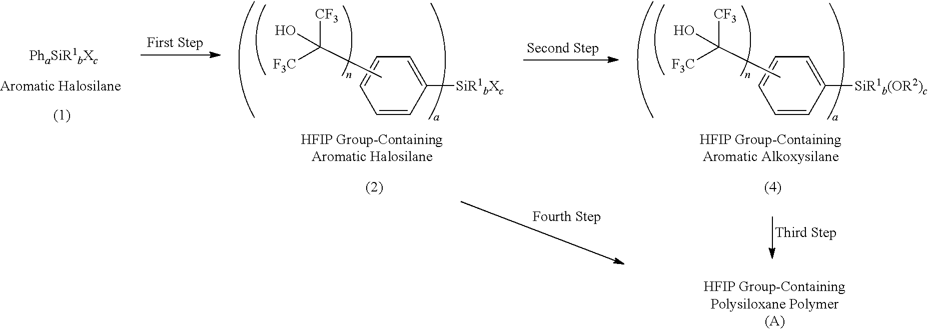

Hereinafter, the HFIP-containing aromatic halosilane (2) and the first to fourth steps according to the present invention will be explained below one by one.

2. HFIP Group-Containing Aromatic Halosilane (2) (Novel Compound)

The HFIP-containing aromatic halosilane (2) according to the present invention has a structure in which a HFIP group(s) and a silicon atom are directly bonded to an aromatic ring as represented by the general formula (2).

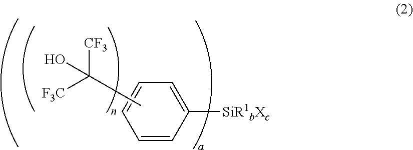

In the above formula, R¹ is each independently a C₁-C₁₀ linear or C₃-C₁₀ branched or cyclic alkyl group, or a C₂-C₁₀ linear or C₃-C₁₀ branched or cyclic alkenyl group; a part or all of hydrogen atoms of the alkyl group or alkenyl group as R¹ may be substituted with a fluorine atom; X is a halogen atom; a is an integer of 1 to 3; b is an integer of 0 to 2; c is an integer of 1 to 3; a relationship of a+b+c=4 is satisfied; and n is an integer of 1 to 5.

Among others, it is preferable that the following group (2_{HFIP}) in the formula (2) is any of those represented by the above-indicated formulas (2A) to (2D)

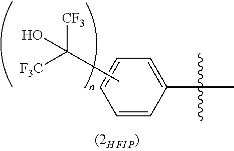

where a wavy line represents a line which the wavy line intersects is a bond (the same applies to the following).

In the silicon compound of the formula (2), it is preferable that X is a chlorine atom. Further, it is preferable that b is 0 or 1 in the silicon compound of the formula (2). As R¹, a C₁-C₆ alkyl group is preferable in terms of the availability of the raw material compound. Particularly preferable is a methyl group.

It is generally preferable that a is 1 in terms of ease of synthesis. It is also preferable that n is 1 in terms of ease of synthesis.

3. First Step

The first step will be now explained below. The first step is a step of reacting the aromatic halosilane of the formula (1) with HFA in the presence of the Lewis acid catalyst, thereby obtaining the HFIP-containing aromatic halosilane of the formula (2).

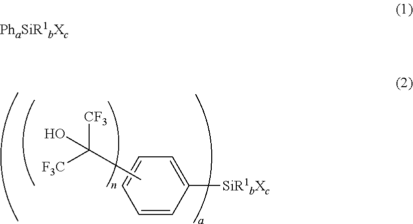

In the above formulas, Ph is an unsubstituted phenyl group; R¹ is each independently a C₁-C₁₀ linear, C₃-C₁₀ branched or C₃-C₁₀ cyclic alkyl group, or a C₂-C₁₀ linear, C₃-C₁₀ branched or C₃-C₁₀ cyclic alkenyl group; a part or all of hydrogen atoms of the alkyl group or alkenyl group as R¹ may be substituted with a fluorine atom; X is a halogen atom; a is an integer of 1 to 3; b is an integer of 0 to 2; c is an integer of 1 to 3; a relationship of a+b+c=4 is satisfied; and n is an integer of 1 to 5.

Preferable examples of the respective symbols are the same as those mentioned in the above section “2. HFIP Group-Containing Aromatic Halosilane (2)”.

In this reaction step, the HFIP-containing aromatic halosilane (2) is obtained by aromatic electrophilic addition reaction of the HFA to the aromatic halosilane (1) under heated conditions in the presence of the Lewis acid catalyst as shown in the following reaction scheme.

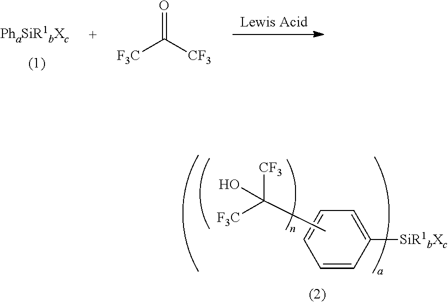

More specifically, the HFIP-containing aromatic halosilane (2) can be obtained by placing and mixing the aromatic halosilane (1) and the Lewis acid catalyst in a reaction container, introducing the HFA into the reaction container to carry out the reaction, and then, subjecting the reaction product to distillation purification etc.

The raw material compounds, reaction product, catalyst and reaction conditions of the first step will be explained below.

[Aromatic Halosilane (1)]

The aromatic halosilane (1) as the raw material compound has a structure in which a phenyl group to be reacted with the hexafluoroacetone and a halogen atom are directly bonded to a silicon atom as represented by the general formula (1).

The aromatic halosilane (1) may have a substituent group R¹ directly bonded to the silicon atom. Specific examples of the substituent group R¹ are methyl, ethyl, propyl, butyl, isobutyl, t-butyl, neopentyl, octyl, cyclohexyl, trifluoromethyl, 1,1,1-trifluoropropyl, perfluorohexyl, perfluorooctyl and the like. Among others, methyl is preferred as the sub stituent group R¹ in terms of the availability of the aromatic halosilane compound. Further, it is preferable that b is 0 or 1 because, in the case of b=0 or 1, the first step is high in yield. It is more preferable that b is 0 because, in the case of b=0, the first step is particularly high in yield (see Example 1 of the present specification).

Specific examples of the halogen atom X of the aromatic halosilane (1) are fluorine, chlorine, bromine and iodine. Among others, chlorine is preferred as the halogen atom X of the aromatic halosilane (1) in terms of the availability and stability of the aromatic halosilane compound.

[Lewis Acid Catalyst]

There is no particular limitation on the kind of the Lewis acid catalyst used in this reaction step. Specific examples of the Lewis acid catalyst are aluminum chloride, iron (III) chloride, zinc chloride, tin (II) chloride, titanium tetrachloride, aluminum bromide, boron trifluoride, boron trifluoride-diethyl ether complex, antimony fluoride, zeolites, composite oxides and the like. Among others, aluminum chloride, iron (III) chloride and boron trifluoride are preferred. More preferred is aluminum chloride because it shows high reactivity in the reaction. There is no particular limitation on the amount of the Lewis acid catalyst used. It is preferable to use the Lewis acid catalyst in an amount of 0.01 mol to 1.0 mol per 1 mol of the aromatic halosilane (1).

[Organic Solvent]

In the case where the aromatic halosilane (1) as the raw material is liquid, the reaction can be performed without specifically using an organic solvent. In the case where the aromatic halosilane (1) as the raw material is solid or is high in reactivity, by contrast, an organic solvent can be used in the reaction. There is no particular limitation on the kind of the organic solvent as long as the organic solvent is capable of dissolving therein the aromatic halosilane (1) and does not react with the Lewis acid catalyst and the HFA. Specific examples of the organic solvent are pentane, hexane, heptane, octane, acetonitrile, nitromethane, chlorobenzene, nitrobenzene and the like. These solvents can be used solely or in the form of a mixture thereof.

[Hexafluoroacetone (HFA)]

Since the first step is originally an anhydrous reaction step, the HFA used is preferably in anhydrous form (i.e. gas form under ordinary temperatures). It is thus preferable to use the respective reagents in the form of anhydrides commonly available to those skilled in the art. There is no particular limitation on the water content of the reaction system. If water is present in the reaction system, however, the catalyst such as aluminum chloride is deactivated by reaction with the water so that the amount of the catalyst consumed is increased. For this reason, the water content of the reaction system is generally 1 g or less, preferably 0.1 g or less, per 100 g of the total amount of the reagents although the upper limit is not particularly set for the water content of the reaction system. The amount of the HFA used varies depending on the number of HFIP groups introduced to the aromatic ring. Preferably, the amount of the HFA used is 1 to 6 molar equivalents per 1 mol of the phenyl group contained in the aromatic halosilane (1) as the raw material. In the case of introducing three or more HFIP groups to the phenyl group, it is necessary to use an excessive amount of the HFA and a large amount of the catalyst and to take a long reaction time. Thus, the amount of the HFA used is more preferably 2.5 molar equivalents or less per 1 mol of the phenyl group contained in the aromatic halosilane (1) as the raw material so that the number of HFIP groups introduced to the phenyl group is limited to 2 or less. The amount of the HFA used is still more preferably 1.5 molar equivalents or less per 1 mol of the phenyl group contained in the aromatic halosilane (1) as the raw material so that the number of HFIP groups introduced to the phenyl group is limited to 1.

[Reaction Conditions]

Herein, the boiling point of the HFA is −28° C. It is thus preferable to use a cooling device or a closed reactor in order for the HFA to remain in the reaction system during the production of the HFIP group-containing aromatic halosilane (2) according to the present invention. Particularly preferably used is a closed reactor. In the case where the reaction is preformed using a closed reactor (such as autoclave), it is preferable to first place the aromatic halosilane and the Lewis acid catalyst in the reactor and then introduce the HFA gas into the reactor such that the pressure inside the reactor does not exceed 0.5 MPa.

The suitable reaction temperature in this reaction step largely varies depending on the kind of the aromatic halosilane (1) used as the raw material. It is preferable that the reaction temperature is in the range of −20° C. to 120° C. The reaction is preferably performed at a lower temperature as the raw material has a higher electron density on the aromatic ring and shows a higher electrophilicity. The yield of the HFIP group-containing aromatic halosilane (2) is improved by performing the reaction at as low a temperature as possible and thereby suppressing cleavage of a Ph-Si bond of the aromatic halosilane during the reaction. More specifically, the reaction is preferably performed in the temperature range of −20° C. to 50° C.

There is no particular limitation on the reaction time in this reaction step. The reaction time is set as appropriate depending on the amount of the HFIP group introduced, the temperature, the amount of the catalyst used etc. In order for the reaction to proceed sufficiently, it is preferable to continue the reaction for 1 to 24 hours after the introduction of the HFA.

Further, it is preferable to end the reaction after confirming that the raw material has been sufficiently consumed by general-purpose analytical means such as gas chromatography. After the completion of the reaction, the HFIP group-containing aromatic halosilane (2) is obtained by purification operation such as filtration, extraction, distillation etc.

The HFIP group-containing aromatic halosilane (2) obtained in the first step is in the form of a mixture of a plurality of isomers with different substitution numbers and positions of HFIP groups. As mentioned above, n is defined as an integer of 1 to 5. However, n is generally 1 in the case where the reaction of the first step is performed under normal conditions. The HFIP group-containing aromatic halosilane (2) is often obtained as a mixture of 1,2-, 1,3- and 1,4-isomers corresponding to the above-indicated partial structural formulas (2A), (2B) and (2C). It is common that the 1,3-isomer becomes the most major product.

The respective 1,2-, 1,3- and 1,4-isomers of the HFIP group-containing aromatic halosilane (2) obtained in the first step are useful and reacted comparably in the subsequent second and third steps. These respective isomers are high in usefulness from the viewpoint of production of the HFIP group-containing polysiloxane polymer (A) as the final product. It is feasible to separate one of the isomers obtained in the first step by isolation owing to boiling point differences and then use the separated isomer in the subsequent step. Alternatively, it is feasible to subject all of the isomers obtained in the first step to the subsequent second and third steps or to the subsequent fourth step without separation (e.g. in the form of a mixture of the 1,2-, 1,3- and 1,4-isomers) (in this case, the final product of the third step or forth step is obtained as a mixture of reaction products derived from the respective isomers). A person skilled in the art can select which way to use, without particular limitation, depending on the use of the final product.

4. Second Step

Next, the second step will be explained below. The second step is a step of reacting the HFIP group-containing aromatic halosilane (2) obtained in the first step with the alcohol of the formula (3), thereby forming to the HFIP group-containing aromatic alkoxysilane of the formula (4).

R²OH (3)

In the above formula, R² is a C₁-C₄ linear or C₃-C₄ branched alkyl group; and a part or all of hydrogen atoms of the alkyl group as R² may be substituted with a fluorine atom.

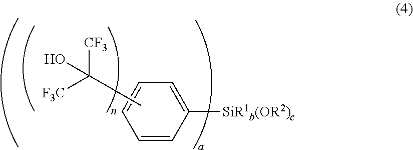

In the above formula, R¹ is each independently a C₁-C₁₀ linear, C₃-C₁₀ branched or C₃-C₁₀ cyclic alkyl group, or a C₂-C₁₀ linear, C₃-C₁₀ branched or C₃-C₁₀ cyclic alkenyl group; a part or all of hydrogen atoms of the alkyl group or alkenyl group as R¹ may be substituted with a fluorine atom; a is an integer of 1 to 3; b is an integer of 0 to 2; c is an integer of 1 to 3; a relationship of a+b+c=4 is satisfied; n is an integer of 1 to 5; R² is each independently a C₁-C₄ linear or C₃-C₄ branched alkyl group; and a part or all of hydrogen atoms of the alkyl group as R² may be substituted with a fluorine atom.

In the this reaction step, the HFIP group-containing aromatic alkoxysilane (4) is formed by reaction of the HFIP group-containing aromatic halosilane (2) with the alcohol of the formula (3) as shown in the following reaction scheme.

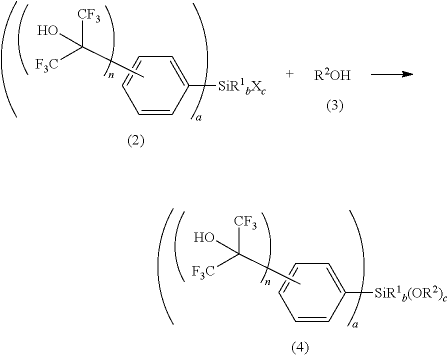

In the reaction scheme, X is a halogen atom.

The raw reactant compounds, reaction product and reaction conditions of the second step will be explained below.

[HFIP Group-Containing Aromatic Halosilane (2)]

It is preferable to use, as the raw reactant material, the HFIP group-containing aromatic halosilane (2) obtained in the first step. The HFIP group-containing aromatic halosilane (2) may be in the form of any of various isomers separated by precision distillation etc. Alternatively, various isomers of the HFIP group-containing aromatic halosilane (2) obtained in the first step may be used, as they are without separation, as the raw reactant material.

[Alcohol]

The alcohol (3) is selected depending on the target HFIP group-containing aromatic alkoxysilane (4). Specific examples of the alcohol (3) are methanol, ethanol, 1-propanol, 2-propanol, 2-fluoroethanol, 2,2,2-trifluoroethanol, 3-fluoropropanol, 3,3-difluoropropanol, 3,3,3-trifluoropropanol, 2,2,3,3-tetrafluoropropanol, 2,2,3,3,3-pentafluoropropanol, 1,1,1,3,3,3-hexafluoroisopropanol and the like. Among others, methanol or ethanol is preferred. When water is contained in the alcohol (3) during the reaction of the alcohol (3) with the HFIP group-containing aromatic halosilane (2), hydrolysis or polycondensation of the HFIP group-containing aromatic halosilane (2) proceeds so that the yield of the target HFIP group-containing aromatic alkoxysilane (4) becomes lowered. It is thus preferable that the alcohol is low in water content. The water content of the alcohol is preferably 5 wt % or less, more preferably 1 wt % or less.

[Reaction Conditions]

In the present invention, there is no particular limitation on the reaction technique for production of the HFIP group-containing aromatic alkoxysilane (4). As a typical example, it is feasible to perform the reaction by dropping the alcohol (3) into the HFIP group-containing aromatic halosilane (2) or by dropping the HFIP group-containing aromatic halosilane (2) into the alcohol (3).

There is no particular limitation on the amount of the alcohol (3) used. In order for the reaction to proceed efficiently, the amount of the alcohol (3) used is preferably 1 to 10 molar equivalents, more preferably 1 to 3 molar equivalents, per Si—X bond contained in the HFIP group-containing aromatic halosilane (2).

There is also no particular limitation on the dropping time of the alcohol (3) or the HFIP group-containing aromatic halosilane (2). The dropping time is preferably 10 minutes to 24 hours, more preferably 30 minutes to 6 hours. The suitable reaction temperature during the dropping varies depending on the reaction conditions. More specifically, the reaction temperature during the dropping is preferably 0° C. to 70° C.

The reaction can be finished by aging with continuous stirring after the completion of the dropping. There is no particular limitation on the aging time. The aging time is preferably 30 minutes to 6 hours in order for the desired reaction to proceed sufficiently. The reaction temperature during the aging is preferably equal to or higher than the reaction temperature during the dropping. More specifically, the reaction temperature during the aging is preferably 10° C. to 80° C.

Since the reactivity between the alcohol (3) and the HFIP group-containing aromatic halosilane (2) is high, a halogenosilyl group of the halosilane is promptly converted to an alkoxysilyl group during the reaction. In order to promote the reaction and suppress side reactions, it is preferable to remove a hydrogen halide generated during the reaction. One conceivable technique of removing the hydrogen halide is to add a known hydrogen halide scavenger such as amine compound, orthoester, sodium alkoxide, epoxy compound, olefin etc. Another conceivable technique is to remove the generated hydrogen halide gas from the reaction system by heating or bubbling with dry nitrogen gas. These techniques can be used solely or in combination of a plurality thereof.

As the hydrogen halide scavenger, there can suitably be used an orthoester or a sodium alkoxide. Specific examples of the orthoester are trimethyl orthoformate, triethyl orthoformate, tripropyl orthoformate, triisopropyl orthoformate, trimethyl orthoacetate, triethyl orthoacetate, trimethyl orthopropionate, trimethyl orthobenzoate and the like. In terms of the availability, preferred is trimethyl orthoformate or triethyl orthoformate. Specific examples of the sodium alkoxide are sodium methoxide, sodium ethoxide and the like.

During the reaction of the alcohol (3) and the HFIP group-containing aromatic halosilane (2), the reaction system may be diluted with a solvent. There is no particular limitation on the kind of the diluent solvent used as long as the diluent solvent does not react with the alcohol (3) and with the HFIP group-containing aromatic halosilane (2). Specific examples of the diluent solvent are pentane, hexane, heptane, octane, toluene, xylene, tetrahydrofuran, diethyl ether, dibutyl ether, diisopropyl ether, 1,2-dimethoxyethane, 1,4-dioxane and the like. These solvents can be used solely or in the form of a mixture thereof.

Further, it is preferable to end the reaction after confirming that the raw reactant materials have been sufficiently consumed by general-purpose analytical means such as gas chromatography. After the completion of the reaction, the HFIP group-containing aromatic alkoxysilane (4) is obtained by purification operation such as filtration, extraction, distillation etc.

In the case where the respective isomers of the HFIP group-containing aromatic halosilane (2) obtained in the first step are used in the second step as they are without separation, the HFIP group-containing aromatic alkoxysilane (4) is obtained as a mixture of isomers with the same composition ratio as that of those raw material isomers. It is feasible to separate one of the isomers obtained in the second step by isolation owing to boiling point differences and then use the separated isomer in the subsequent step. Alternatively, it is feasible to subject all of the isomers obtained in the second step to the subsequent third step without separation (e.g. in the form of a mixture of the 1,2-, 1,3- and 1,4-isomers) (in this case, the final product of the third step is obtained as a mixture of reaction products derived from the respective isomers). A person skilled in the art can select which way to use, without particular limitation, depending on the use of the final product.

In the case of utilizing the first and second steps in combination, it is preferable that: X is a chlorine atom; R² is a methyl group or an ethyl group; b is 0 or 1; and the Lewis acid catalyst used in the first step is selected from the group consisting of aluminum chloride, iron (III) chloride and boron trifluoride because, in such a case, the total yield becomes high.

### 5. Third Step

The third step will be next explained below. The third step is a step of subjecting the HFIP group-containing aromatic alkoxysilane (4) formed in the second step to hydrolysis and polycondensation, thereby obtaining the HFIP group-containing polysiloxane polymer (A) with the repeating unit of the formula (5).

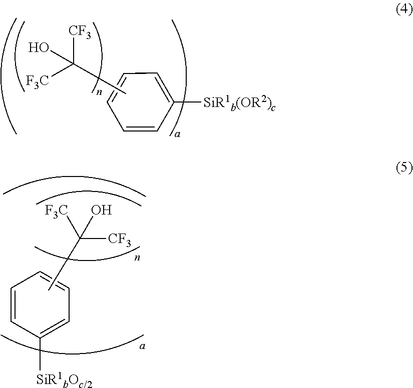

In the above formulas, R¹ is each independently a C₁-C₁₀ linear, C₃-C₁₀ branched or C₃-C₁₀ cyclic alkyl group, or a C₂-C₁₀ linear, C₃-C₁₀ branched or C₃-C₁₀ cyclic alkenyl group; a part or all of hydrogen atoms of the alkyl group or alkenyl group as R¹ may be substituted with a fluorine atom; a is an integer of 1 to 3; b is an integer of 0 to 2; c is an integer of 1 to 3; a relationship of a+b+c=4 is satisifed; n is an integer of 1 to 5; R² is each independently a C₁-C₄ linear or C₃-C₄ branched alkyl group; and a part or all of hydrogen atoms of the alkyl group as R² may be substituted with a fluorine atom.

In the production of the HFIP group-containing polysiloxane polymer (A), the HFIP group-containing aromatic alkoxysilane (4) may be copolymerized with another hydrolyzable silane such as chlorosilane, alkoxysilane or silicate oligomer.

[Chlorosilane]

Specific examples of the chlorosilane are dimethyldichlorosilane, diethyldichlorosilane, dipropyldichlorosilane, diphenyldichlorosilane, bis(3,3,3-trifluoropropyl)dichlorosilane, methyl(3,3,3-trifluoropropyl)dichlorosilane, methyltrichlorosilane, ethyltrichlorosilane, propyltrichlorosilane, isopropyltrichlorosilane, phenyltrichlorosilane, trifluoromethyltrichlorosilane, pentafluoroethyltrichlorosilane, 3,3,3-trifluoropropyltrichlorosilane, tetrachlorosilane and the HFIP-containing aromatic halosilane (2) obtained in the first step.

[Alkoxysilane]

Specific examples of the alkoxysilane are dimethyldimethoxysilane, dimethyldiethoxysilane, dimethyldipropoxysilane, dimethyldiphenoxysilane, diethyldimethoxysilane, diethyldiethoxysilane, diethyldipropoxysilane, diethyldiphenoxysilane, dipropyldimethoxysilane, dipropyldiethoxysilane, diphenyldimethoxysilane, diphenyldiethoxysilane, diphenyldiphenoxysilane, bis(3,3,3-trifluoropropyl)dimethoxysilane, methyl(3,3,3-trifluoropropyl)dimethoxysilane, methyltrimethoxysilane, ethyltrimethoxysilane, propyltrimethoxysilane, isopropyltrimethoxysilane, phenyltrimethoxysilane, methyltriethoxysilane, ethyltriethoxysilane, propyltriethoxysilane, isopropyltriethoxysilane, phenyltriethoxysilane, methyltripropoxysilane, ethyltripropoxysilane, propyltripropoxysilane, isopropyltripropoxysilane, phenyltripropoxysilane, methyltriisopropoxysilane, ethyltriisopropoxysilane, propyltriisopropoxysilane, isopropyltriisopropoxysilane, phenyltriisopropoxysilane, trifluoromethyltrimethoxysilane, pentafluoroethyltrimethoxysilane, 3,3,3-trifluoropropyltrimethoxysilane, 3,3,3-trifluoropropyltriethoxysilane, tetramethoxysilane, tetraethoxysilane, tetrapropoxysilane and tetraisopropoxysilane.

[Silicate Oligomer]

In the present specification, the silicate oligomer refers to an oligomer obtained by hydrolysis and polycondensation of a tetraalkoxysilane. Specific examples of the silicate oligomer are commercially available products such as Silicate 40 (pentamer on average; manufactured by Tama Chemicals Co., Ltd.), Ethyl Silicate 40 (pentamer on average; manufactured by Colcoat Co., Ltd.), Silicate 45 (heptamer on average; manufactured by Tama Chemicals Co., Ltd.), M-Silicate 51 (tetramer on average; manufactured by Tama Chemicals Co., Ltd.), Methyl Silicate 51 (tetramer on average; manufactured by Colcoat Co., Ltd.), Methyl Silicate 53A (heptamer on average; manufactured by Colcoat Co., Ltd.), Ethyl Silicate 48 (decamer on average; manufactured by Colcoat Co., Ltd.) and EMS-485 (mixture of ethyl silicate and methyl silicate; manufactured by Colcoat Co., Ltd.).

The above chlorosilanes, alkoxysilanes and silicate oligomers can be used solely or in the form of a mixture of two or more kinds thereof.

The amount of the HFIP group-containing aromatic alkoxysilane (4) used in the copolymerization is preferably 10 mol % or more, more preferably 30 mol % or more, per 100 mol % of the total use amount of the HFIP group-containing aromatic alkoxysilane (4) and the hydrolyzable silane such as chlorosilane, alkoxysilane etc.

[Reaction Conditions]

In this reaction step, the hydrolysis and polycondensation reaction can be performed by a method commonly used for hydrolysis and condensation of alkoxysilanes. One example of the reaction method is as follows. First, a predetermined amount of the HFIP group-containing aromatic alkoxysilane (4) is charged into a reactor at room temperature (that is, at ambient temperature without heating and cooling; generally ranging from about 15° C. to about 30° C.; the same applies to the following). After that, water for the hydrolysis of the HFIP group-containing aromatic alkoxysilane (4), a catalyst for the polycondensation and optionally a reaction solvent are charged into the reactor. With this, there is obtained a reaction mixture. The order of charging of the reaction materials is not particularly limited to this order. The reaction mixture can be obtained by charging the reaction materials in an arbitrary order into the reactor. In the case of using another hydrolyzable silane in combination, the another hydrolyzable silane can be charged into the reactor in the same manner as the HFIP group-containing aromatic alkoxysilane (4). Subsequently, the reaction mixture is stirred at a predetermined temperature for a predetermined time so that the hydrolysis and condensation reaction proceeds to form the HFIP group-containing polysiloxane polymer (A). The time required for the hydrolysis and polycondensation reaction varies depending on the kind of the catalyst used. Generally, the reaction time is 3 to 24 hours. Further, the reaction temperature is generally higher than or equal to room temperature and lower than or equal to 180° C. In the case of performing the reaction under heating, it is preferable to use the reactor of the closed type, or reflux the reaction system with the use of a reflux device such as condenser, in order to prevent the unreacted raw material, water, reaction solvent and/or catalyst from being evaporated to the outside of the reaction system. After the reaction, it is preferable to remove the water, alcohol product and catalyst remaining in the reaction system in terms of the handling of the HFIP group-containing polysiloxane polymer (A). The water, alcohol and catalyst can be removed by extraction or by adding any solvent that does not affect the reaction, such as toluene, and then, conducting azeotropic distillation through a Dean-Stark tube.

There is no particular limitation on the amount of the water used in the hydrolysis and condensation reaction. In terms of the reaction efficient, the amount of the water used is preferably more than or equal to 0.5 times and less than or equal to 5 times the total mole number of hydrolyzable groups (alkoxy group and chlorine atom group) contained in the raw reactant material such as alkoxysilane, chlorosilane etc.

[Catalyst]

There is no particular limitation on the catalyst used for the polycondensation reaction. An acid catalyst or base catalyst can suitably be used. Specific examples of the acid catalyst are hydrochloric acid, nitric acid, sulfuric acid, hydrofluoric acid, phosphoric acid, acetic acid, trifluoroacetic acid, methanesulfonic acid, trifluoromethanesulfonic acid, camphorsulfonic acid, benzenesulfonic acid, tosylic acid, formic acid, polycarboxylic acid, anhydrides thereof and the like. Specific examples of the base catalyst are triethylamine, tripropylamine, tributylamine, tripentylamine, trihexylamine, triheptylamine, trioctylamine, diethylamine, triethanolamine, diethanolamine, sodium hydroxide, potassium hydroxide, sodium carbonate and the like. The amount of the catalyst used is preferably more than or equal to 1.0×10⁻⁵ times and less than or equal to 1.0×10⁻¹ times the total mole number of hydrolyzable groups (alkoxy group and chlorine atom group) contained in the raw reactant material such as alkoxysilane, chlorosilane etc.

[Reaction Solvent]

In the hydrolysis and polycondensation reaction, the reaction solvent is not necessarily used. The hydrolysis and polycondensation reaction can be performed by mixing the raw reactant material, water and catalyst together. In the case of using the reaction solvent, there is no particular limitation on the kind of the reaction solvent used. The reaction solvent is preferably a polar solvent, more preferably an alcohol solvent, in terms of the solubility of the raw reactant material, water and catalyst in the reaction solvent. Specific examples of the reaction solvent are methanol, ethanol, 1-propanol, 2-propanol, 1-butanol, 2-butanol and the like. The reaction solvent can be used in any arbitrary amount required for the hydrolysis and polycondensation to proceed in a homogeneous system.

### 6. Fourth Step

The fourth step will be next explained below. The fourth step is a step of subjecting the HFIP group-containing aromatic halosilane (2) obtained in the first step to hydrolysis and polycondensation, thereby obtaining the HFIP group-containing polysiloxane polymer (A) with the repeating unit of the formula (5).

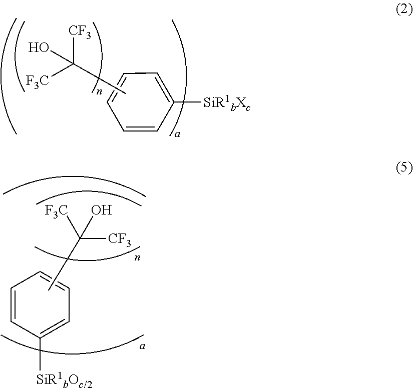

In the above formulas, R¹ is each independently a C₁-C₁₀ linear, C₃-C₁₀ branched or C₃-C₁₀ cyclic alkyl group, or a C₂-C₁₀ linear, C₃-C₁₀ branched or C₃-C₁₀ cyclic alkenyl group; a part or all of hydrogen atoms of the alkyl group or alkenyl group as R¹ may be substituted with a fluorine atom; X is a halogen atom; a is an integer of 1 to 3; b is an integer of 0 to 2; c is an integer of 1 to 3; a relationship of a+b+c=4 is satisfied; n is an integer of 1 to 5; R² is each independently a C₁-C₄ linear or C₃-C₄ branched alkyl group; and a part or all of hydrogen atoms of the alkyl group as R² may be substituted with a fluorine atom.

In the production of the HFIP group-containing polysiloxane polymer (A), the HFIP group-containing aromatic halosilane (2) may be copolymerized with another hydrolyzable silane such as chlorosilane, alkoxysilane or silicate oligomer.

[Chlorosilane]

Specific examples of the chlorosilane are dimethyldichlorosilane, diethyldichlorosilane, dipropyldichlorosilane, diphenyldichlorosilane, bis(3,3,3-trifluoropropyl)dichlorosilane, methyl(3,3,3-trifluoropropyl)dichlorosilane, methyltrichlorosilane, ethyltrichlorosilane, propyltrichlorosilane, isopropyltrichlorosilane, phenyltrichlorosilane, trifluoromethyltrichlorosilane, pentafluoroethyltrichlorosilane, 3,3,3-trifluoropropyltrichlorosilane and tetrachlorosilane.

[Alkoxysilane]

Specific examples of the alkoxysilane are dimethyldimethoxysilane, dimethyldiethoxysilane, dimethyldipropoxysilane, dimethyldiphenoxysilane, diethyldimethoxysilane, diethyldiethoxysilane, diethyldipropoxysilane, diethyldiphenoxysilane, dipropyldimethoxysilane, dipropyldiethoxysilane, diphenyldimethoxysilane, diphenyldiethoxysilane, diphenyldiphenoxysilane, bis(3,3,3-trifluoropropyl)dimethoxysilane, methyl(3,3,3-trifluoropropyl)dimethoxysilane, methyltrimethoxysilane, ethyltrimethoxysilane, propyltrimethoxysilane, isopropyltrimethoxysilane, phenyltrimethoxysilane, methyltriethoxysilane, ethyltriethoxysilane, propyltriethoxysilane, isopropyltriethoxysilane, phenyltriethoxysilane, methyltripropoxysilane, ethyltripropoxysilane, propyltripropoxysilane, isopropyltripropoxysilane, phenyltripropoxysilane, methyltriisopropoxysilane, ethyltriisopropoxysilane, propyltriisopropoxysilane, isopropyltriisopropoxysilane, phenyltriisopropoxysilane, trifluoromethyltrimethoxysilane, pentafluoroethyltrimethoxysilane, 3,3,3-trifluoropropyltrimethoxysilane, 3,3,3-trifluoropropyltriethoxysilane, tetramethoxysilane, tetraethoxysilane, tetrapropoxysilane, tetraisopropoxysilane and the HFIP group-containing aromatic alkoxysilane (4) obtained in the second step.

[Silicate Oligomer]

Specific examples of the silicate oligomer include the above-mentioned commercially available products.

The above chlorosilanes, alkoxysilanes and silicate oligomers can be used solely or in the form of a mixture of two or more kinds thereof.

The amount of the HFIP group-containing aromatic halosilane (2) used in the copolymerization is preferably 10 mol % or more, more preferably 30 mol % or more, per 100 mol % of the total use amount of the HFIP group-containing aromatic halosilane (2) and the hydrolyzable silane such as chlorosilane, alkoxysilane etc.

[Reaction Conditions]

In this reaction step, the hydrolysis and polycondensation reaction can be performed by a method commonly used for hydrolysis and condensation of chlorosilanes. One example of the reaction method is as follows. First, a predetermined amount of the HFIP group-containing aromatic halosilane (2) is charged into a reactor at room temperature (that is, at ambient temperature without heating and cooling; generally ranging from about 15° C. to about 30° C.; the same applies to the following). A catalyst for the polycondensation and a reaction solvent are optionally charged into the reactor. After that, water for the hydrolysis of the HFIP group-containing aromatic halosilane (2) is charged into the reactor. With this, there is obtained a reaction mixture. The order of charging of the reaction materials is not particularly limited to this order. The reaction mixture can be obtained by charging the reaction materials in an arbitrary order into the reactor. In the case of using another hydrolyzable silane in combination, the another hydrolyzable silane can be charged into the reactor in the same manner as the HFIP group-containing aromatic halosilane (2). Subsequently, the reaction mixture is stirred at a predetermined temperature for a predetermined time so that the hydrolysis and condensation reaction proceeds to form the HFIP group-containing polysiloxane polymer (A). The time required for the hydrolysis and polycondensation reaction varies depending on the kind of the catalyst used. Generally, the reaction time is 3 to 24 hours. Further, the reaction temperature is generally higher than or equal to room temperature and lower than or equal to 180° C. In the case of performing the reaction under heating, it is preferable to use the reactor of the closed type, or reflux the reaction system with the use of a reflux device such as condenser, in order to prevent the unreacted raw material, water, reaction solvent and/or catalyst from being evaporated to the outside of the reaction system. After the reaction, it is preferable to remove the water and catalyst remaining in the reaction system in terms of the handling of the HFIP group-containing polysiloxane polymer (A). The water and catalyst can be removed by extraction or by adding any solvent that does not affect the reaction, such as toluene, and then conducting azeotropic distillation through a Dean-Stark tube.

There is no particular limitation on the amount of water used in the hydrolysis and condensation reaction. In terms of the reaction efficient, the amount of water used is preferably more than or equal to 0.5 times and less than or equal to 5 times the total mole number of hydrolyzable groups (halogen atom group and alkoxy group) contained in the raw reactant material.

In general, there is no need to newly add a catalyst because hydrogen halide generated by the hydrolysis serves as a catalyst. A catalyst may however be added. In such a case, an acid catalyst can suitably be used. Specific examples of the acid catalyst are hydrochloric acid, nitric acid, sulfuric acid, hydrofluoric acid, phosphoric acid, acetic acid, trifluoroacetic acid, methanesulfonic acid, trifluoromethanesulfonic acid, camphorsulfonic acid, benzenesulfonic acid, tosylic acid, formic acid, polycarboxylic acid, anhydrides thereof and the like. The amount of the catalyst used is preferably more than or equal to 1.0×10⁻⁵ times and less than or equal to 1.0×10⁻¹ times the total mole number of hydrolyzable groups (halogen atom group and alkoxy group) contained in the raw reactant material.

In the hydrolysis and polycondensation reaction, a reaction solvent is not necessarily used. The hydrolysis and polycondensation reaction can be performed by mixing the raw reactant material and water together. In the case of using the reaction solvent, there is no particular limitation on the kind of the reaction solvent used. The reaction solvent is preferably a polar solvent, more preferably an alcohol solvent, in terms of the solubility of the raw reactant material, water and catalyst in the reaction solvent.

Specific examples of the reaction solvent are methanol, ethanol, 1-propanol, 2-propanol, 1-butanol, 2-butanol and the like. The reaction solvent can be used in any arbitrary amount required for the hydrolysis and polycondensation to proceed in a homogeneous system.

### EXAMPLES

The present invention will be described in more detail below by way of the following examples. It should however be understood that the present invention is not limited to the following examples.

The identification of silicon compounds obtained in the following respective examples was done by the following methods.

[NMR (Nuclear Magnetic Resonance) Measurement]

¹H-NMR and ¹⁹F-NMR measurements were carried out using a nuclear magnetic resonance apparatus (JNM-ECA400 manufactured by JEOL Ltd.) with a resonance frequency of 400 MHz.

[GC Measurement]

GC measurement was carried out using a gas chromatograph manufactured as Shimadzu GC-2010 by Shimadzu Corporation with a capillary column DB1 (60 mm×0.25 mmϕ×1 μm).

[Determination of Molecular Weight]

Using a gel permeation chromatography system (HLC-8320GPC manufactured by Tosoh Corporation), a GPC of the polymer compound was measured. Then, the weight-average molecular weight (Mw) of the polymer compound in terms of polystyrene was determined from the measured chromatogram.

### Example 1

### First Step: Reaction of Phenyltrichlorosilane and HFA

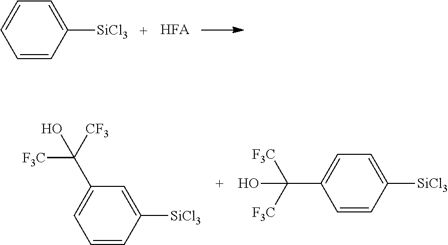

Into a 300-mL autoclave with a stirrer, 26.92 g (600 mmol) of phenyltrichlorosilane and 8.00 g (60.0 mmol) of aluminum chloride were charged. The inside of the autoclave was replaced with nitrogen, followed by raising the temperature inside the autoclave to 40° C. Then, 119.81 g (722 mmol) of HFA was introduced into the autoclave over 2 hours. This reaction mixture was kept stirred for 3 hours. After the completion of the reaction, solid matter was removed from the reaction mixture by pressure filtration. The resulting crude product was distilled under reduced pressure, thereby obtaining 215.54 g of a colorless liquid product (with a yield of 95%). The liquid product was analyzed by ¹H-NMR, ¹⁹F-NMR and GC measurements. As a result of the measurements, the liquid product was found to be a mixture of 3-(2-hydroxy-1,1,1,3,3,3-hexafluoroisopropyl)-trichlorosilylbenzene and 4-(2-hydroxy-1,1,1,3,3,3-hexafluoroisopropyl)-trichlorosilylbenzene (GC area %: total of 1,3- and 1,4-substituted isomers=97.37% (1,3-substituted isomer=93.29%, 1,4-subsituted isomer=4.08%)). By precision distillation of the liquid product, 3-(2-hydroxy-1,1,1,3,3,3-hexafluoroisopropyl)-trichlorosilylbenzene was obtained as a colorless liquid (with a GC purity of 98%).

The ¹H-NMR and ¹⁹F-NMR measurement results of the obtained 3-(2-hydroxy-1,1,1,3,3,3-hexafluoroisopropyl)-trichlorosilylbenzene are shown below. ¹H-NMR (solvent: CDCl₃, TMS): δ 8.17 (s, 1H), 7.96-7.89 (m, 2H), 7.64-7.60 (dd, J=7.8 Hz, 1H), 3.42 (s, 1H)

¹⁹F-NMR (solvent: CDCl₃, CCl₃F): δ-75.44 (s, 6F)

### Example 2

### First Step: Reaction of Dichloromethylphenylsilane and HFA

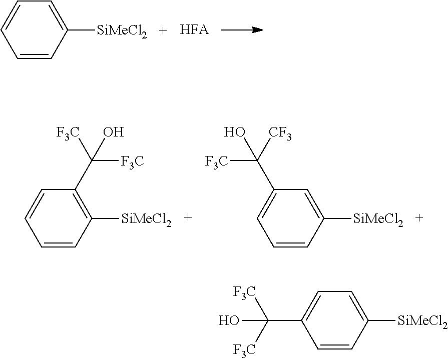

Into a 300-mL autoclave with a stirrer, 114.68 g (600 mmol) of dichloromethylphenylsilane and 8.00 g (60.0 mmol) of aluminum chloride were charged. The inside of the autoclave was replaced with nitrogen, followed by cooling the temperature inside the autoclave to 5° C. Then, 99.61 g (600 mmol) of HFA was introduced into the autoclave over 3 hours. This reaction mixture was kept stirred for 2.5 hours. After the completion of the reaction, solid matter was removed from the reaction mixture by pressure filtration. The resulting crude product was distilled under reduced pressure, thereby obtaining 178.60 g of a colorless liquid product (with a yield of 83%). The liquid product was analyzed by ¹H-NMR, ¹⁹F-NMR and GC measurements. As a result of the measurements, the liquid product was found to be a mixture of 2-(2-hydroxy-1,1,1,3,3,3-hexafluoroisopropyl)-dichloromethylsilylbenzene, 3-(2-hydroxy-1,1,1,3,3,3-hexafluoroisopropyl)-dichloromethylsilylbenzene and 4-(2-hydroxy-1,1,1,3,3,3-hexafluoroisopropyl)-dichloromethylsilylbenzene (GC area %: total of 1,2-, 1,3- and 1,4-substituted isomers=86.34% (1,2-substituted isomer=0.57%, 1,3-substituted isomer=79.33%, 1,4-subsituted isomer=6.44%)).

### Example 3

### First Step: Reaction of Chlorodimethylphenylsilane and HFA

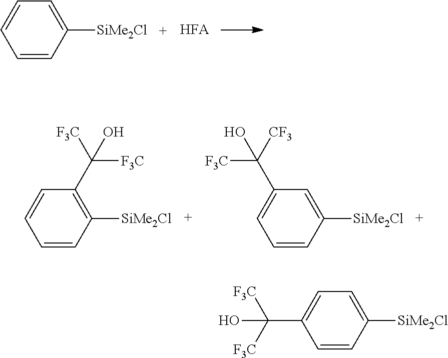

Into a 100-mL autoclave, 17.1 g (100 mmol) of chlorodimethylphenylsilane and 1.33 g (10.0 mmol) of aluminum chloride were charged. The inside of the autoclave was replaced with nitrogen, followed by cooling the temperature inside the autoclave to 5° C. Then, 16.6 g (100 mmol) of HFA was introduced into the autoclave over 40 minutes. This reaction mixture was kept stirred for 2 hours. After the completion of the reaction, solid matter was removed from the reaction mixture by pressure filtration. The resulting crude product was distilled under reduced pressure, thereby obtaining 16.91 g of a colorless liquid product (with a yield of 50%). The liquid product was analyzed by ¹H-NMR, ¹⁹F-NMR and GC measurements. As a result of the measurements, the liquid product was found to be a mixture of 2-(2-hydroxy-1,1,1,3,3,3-hexafluoroisopropyl)-chlorodimethylsilylbenzene, 3-(2-hydroxy-1,1,1,3,3,3-hexafluoroisopropyl)-chlorodimethylsilylbenzene and 4-(2-hydroxy-1,1,1,3,3,3-hexafluoroisopropyl)-chlorodimethylsilylbenzene (GC area %: total of 1,2-, 1,3- and 1,4-substituted isomers=62.34% (1,2-substituted isomer=6.86%, 1,3-substituted isomer=47.68%, 1,4-substituted isomer=7.80%)).

### Example 4

### Second Step: Reaction of HFIP Group-Containing Aromatic Trichlorosilane and Methanol

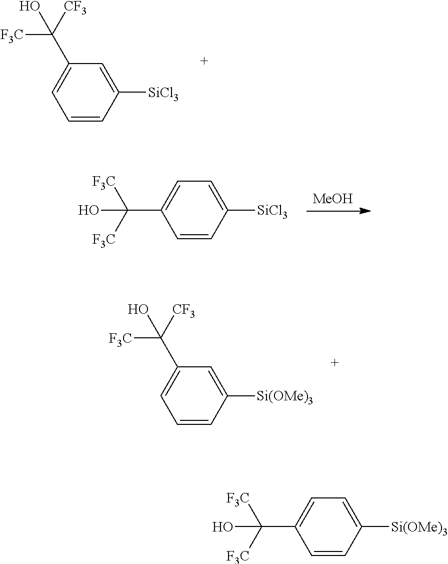

Provided was a 200-mL four-neck flask with a thermometer, a mechanical stirrer and a Dimroth reflux tube. The inside of the flask was replaced with dry nitrogen. Then, 113.27 g of a mixture of 3-(2-hydroxy-1,1,1,3,3,3-hexafluoroisopropyl)-trichlorosilylbenzene and 4-(2-hydroxy-1,1,1,3,3,3-hexafluoroisopropyl)-trichlorosilylbenzene (with a GC area ratio of 1,3-substituted isomer:1,4-substituted isomer=96:4) as obtained by Example 1 was charged into the flask. The mixture inside the flask was heated at 60° C. with stirring. The mixture was then subjected to alkoxylation by dropping 37.46 g (1170 mmol) of anhydrous methanol at 0.5 mL/min through a dropping pump into the mixture while bubbling the mixture with nitrogen to remove hydrogen chloride. After dropping the whole amount of methanol, the resulting reaction mixture was kept stirred for 30 minutes. Subsequently, excess methanol was removed from the reaction mixture by means of a vacuum pump. The reaction mixture was simple-distilled, thereby obtaining 87.29 g of a mixture of 3-(2-hydroxy-1,1,1,3,3,3-hexafluoroisopropyl)-trimethoxysilylbenzene and 4-(2-hydroxy-1,1,1,3,3,3-hexafluoroisopropyl)-trimethoxysilylbenzene (GC area %: total of 1,3- and 1,4-substituted isomers=96.83% (1,3-substituted isomer=92.9%, 1,4-substituted isomer=3.93%)) as a crude product. The yield of the crude product (i.e. the total yield through Examples 1 and 4) with reference to phenyltrichlorosilane was 74%. By precision distillation of the crude product, 3-(2-hydroxy-1,1,1,3,3,3-hexafluoroisopropyl)-trimethoxysilylbenzene was obtained as a white solid (with a GC purity of 98%).

The ¹H-NMR and ¹⁹F-NMR measurement results of the obtained 3-(2-hydroxy-1,1,1,3,3,3-hexafluoroisopropyl)-trimethoxysilylbenzene are shown below. ¹H-NMR (solvent: CDCl₃, TMS): δ 7.98 (s, 1H), 7.82-7.71 (m, 2H), 7.52-7.45 (dd, J=7.8 Hz, 1H), 3.61 (s, 9H) ¹⁹F-NMR (solvent: CDCl₃, CCl₃F): δ-75.33 (s, 6F)

### Example 5

### Second Step: Reaction of HFIP Group-Containing Aromatic Trichlorosilane and Ethanol

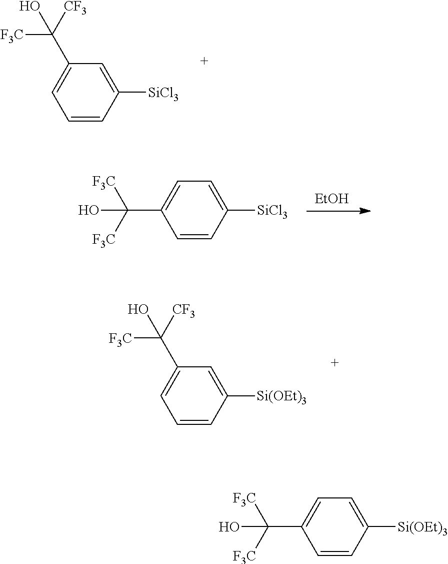

Provided was a 1-L four-neck flask with a thermometer, a mechanical stirrer and a Dimroth reflux tube. The inside of the flask was replaced with dry nitrogen. Then, 47.70 g (1035 mmol) of anhydrous ethanol, 81.00 g (801 mmol) of triethylamine and 300 g of toluene were charged into the flask. The mixture inside the flask was cooled to 0° C. with stirring. Subsequently, 100.00 g of a mixture of 3-(2-hydroxy-1,1,1,3,3,3-hexafluoroisopropyl)-trichlorosilylbenzene and 4-(2-hydroxy-1,1,1,3,3,3-hexafluoroisopropyl)-trichlorosilylbenzene (with a GC area ratio of 1,3-substituted isomer:1,4-substituted isomer=96:4) as obtained by Example 1 was dropped into the flask over 1 hour. During the dropping, the flask was cooled in an ice bath so that the liquid temperature was controlled to 15° C. or lower. After the dropping, the resulting reaction mixture was heated to 30° C. and kept stirred for 30 minutes whereby the reaction was completed. The reaction mixture was subjected to suction filtration to remove a salt. The thus-recovered organic layer was washed three times with 300 g of water by means of a separatory funnel. The toluene was removed from the washed organic layer by means of a rotary evaporator, thereby obtaining 92.24 g of a mixture of 3-(2-hydroxy-1,1,1,3,3,3-hexafluoroisopropyl)-triethoxysilylbenzene and 4-(2-hydroxy-1,1,1,3,3,3-hexafluoroisopropyl)-triethoxysilylbenzene (GC area %: total of 1,3- and 1.4-substituted isomers=91.96% (1,3-substituted isomer=88.26%, 1,4-substituted isomer=3.70%)) as a crude product. The yield of the crude product (i.e. the total yield through Examples 1 and 5) with reference to phenyltrichlorosilane was 82%. By precision distillation of the crude product, 3-(2-hydroxy-1,1,1,3,3,3-hexafluoroisopropyl)-triethoxysilylbenzene was obtained as a colorless transparent liquid (with a GC purity of 97%).

The ¹H-NMR and ¹⁹F-NMR measurement results of the obtained 3-(2-hydroxy-1,1,1,3,3,3-hexafluoroisopropyl)-triethoxysilylbenzene are shown below. ¹H-NMR (solvent: CDCl₃, TMS): δ 8.00 (s, 1H), 7.79-7.76 (m, 2H), 7.47 (t, J=7.8 Hz, 1H), 3.87 (q, J=6.9 Hz, 6H), 3.61 (s, 1H), 1.23 (t, J=7.2 Hz, 9H) ¹⁹F-NMR (solvent: CDCl₃, CCl₃F): δ-75.99 (s, 6F)

### Example 6

### Second Step: Reaction of HFIP Group-Containing Aromatic Trichlorosilane and Ethanol Using Ethanol Solution of Sodium Ethoxide as “Hydrogen Halide Scavenger”

Provided was a 300-mL four-neck flask with a thermometer, a mechanical stirrer and a Dimroth reflux tube. The inside of the flask was replaced with dry nitrogen. Then, 188.80 g of a mixture of 3-(2-hydroxy-1,1,1,3,3,3-hexafluoroisopropyl)-trichlorosilylbenzene and 4-(2-hydroxy-1,1,1,3,3,3-hexafluoroisopropyl)-trichlorosilylbenzene (with a GC area ratio of 1,3-substituted isomer:1,4-substituted isomer=96:4) as obtained by Example 1 was charged into the flask. The mixture inside the flask was heated at 60° C. with stirring. The mixture was then subjected to alkoxylation by dropping 89.80 g (1950 mmol) of anhydrous ethanol at 1 mL/min through a dropping pump into the mixture while bubbling the mixture with nitrogen to remove hydrogen chloride. After dropping the whole amount of ethanol, the resulting reaction mixture was kept stirred for 30 minutes. Subsequently, excess ethanol was removed from the reaction mixture by means of a vacuum pump. By gas chromatographic measurement of the reaction mixture, the amount of unreacted chlorosilanes was determined. To the reaction mixture, 3.39 g (10.0 mmol) of a 20 mass % sodium ethoxide ethanol solution was added. Herein, the amount of the sodium ethoxide ethanol solution added was 1.2 molar equivalent per mole of the chloro groups in the unreacted chlorosilanes. After the reaction mixture was further reacted for 30 minutes, excess ethanol was removed from the reaction mixture by means of a vacuum pump. The reaction mixture was simple-distilled, thereby obtaining 159.58 g of a mixture of 3-(2-hydroxy-1,1,1,3,3,3-hexafluoroisopropyl)-triethoxysilylbenzene and 4-(2-hydroxy-1,1,1,3,3,3-hexafluoroisopropyl)-triethoxysilylbenzene (GC area %: total of 1,3- and 1.4-substituted isomers=95.26% (1,3-substituted isomer=91.58%, 1,4-substituted isomer=3.68%)) as a crude product. The yield of the crude product (i.e. the total yield through Examples 1 and 6) with reference to phenyltrichlorosilane was 75%. By precision distillation of the crude product, 3-(2-hydroxy-1,1,1,3,3,3-hexafluoroisopropyl)-triethoxysilylbenzene was obtained as a colorless transparent liquid (with a GC purity of 98%).

### Example 7

### Second Step: Reaction of HFIP Group-Containing Aromatic Trichlorosilane and Ethanol Using Triethyl Orthoformate as “Hydrogen Halide Scavenger”

Provided was a 300-mL four-neck flask with a thermometer, a mechanical stirrer and a Dimroth reflux tube. The inside of the flask was replaced with dry nitrogen. Then, 188.80 g of a mixture of 3-(2-hydroxy-1,1,1,3,3,3-hexafluoroisopropyl)-trichlorosilylbenzene and 4-(2-hydroxy-1,1,1,3,3,3-hexafluoroisopropyl)-trichlorosilylbenzene (with a GC area ratio of 1,3-substituted isomer:1,4-substituted isomer=96:4) as obtained by Example 1 was charged into the flask. The mixture inside the flask was heated at 60° C. with stirring. The mixture was then subjected to alkoxylation by dropping 89.80 g (1950 mmol) of anhydrous ethanol at 1 mL/min through a dropping pump into the mixture while bubbling the mixture with nitrogen to remove hydrogen chloride. After dropping the whole amount of ethanol, the resulting reaction mixture was kept stirred for 30 minutes. Subsequently, excess ethanol was removed from the reaction mixture by means of a vacuum pump. By gas chromatographic measurement of the reaction mixture, the amount of unreacted chlorosilanes was determined. To the reaction mixture, 1.48 g (10.0 mmol) of triethyl orthoformate was added as a hydrogen halide scavenger. Herein, the triethyl orthoformate added was 1.2 molar equivalent per mole of the chloro groups in the unreacted chlorosilanes. After the reaction mixture was further reacted for 30 minutes, excess ethanol, excess triethyl orthoformate and any product of the reaction using the trimethyl orthomormate were removed from the reaction mixture the by means of a vacuum pump. The reaction mixture was simple-distilled, thereby obtaining 159.98 g of a mixture of 3-(2-hydroxy-1,1,1,3,3,3-hexafluoroisopropyl)-triethoxysilylbenzene and 4-(2-hydroxy-1,1,1,3,3,3-hexafluoroisopropyl)-triethoxysilylbenzene (GC area %: total of 1,3- and 1.4-substituted isomers=95.50% (1,3-substituted isomer=92.93%, 1,4-substituted isomer=3.99%)) as a crude product. The yield of the crude product (i.e. the total yield through Examples 1 and 7) with reference to phenyltrichlorosilane was 83%. By precision distillation of the crude product, 3-(2-hydroxy-1,1,1,3,3,3-hexafluoroisopropyl)-triethoxysilylbenzene was obtained as a colorless transparent liquid (with a GC purity of 98%).

### Example 8

### Second Step: Reaction of HFIP Group-Containing Aromatic Dichloromethylsilane and Ethanol using Ethanol Solution of Sodium Ethoxide as “Hydrogen Halide Scavenger”

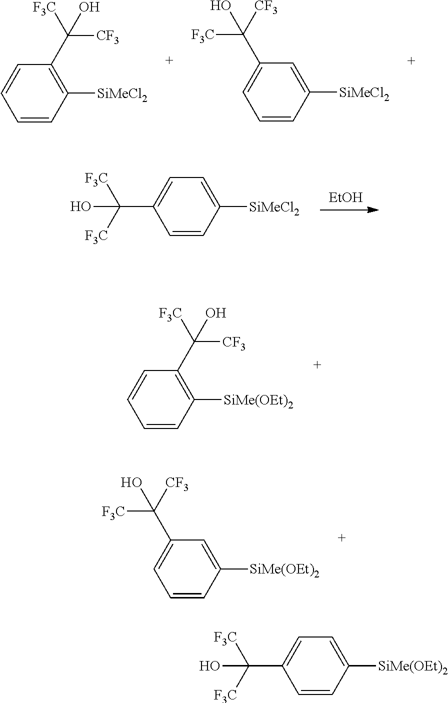

Provided was a 300-mL four-neck flask with a thermometer, a mechanical stirrer and a Dimroth reflux tube. The inside of the flask was replaced with dry nitrogen. Then, 178.60 g of a mixture of 2-(2-hydroxy-1,1,1,3,3,3-hexafluoroisopropyl)-dichloromethylsilylbenzene, 3 -(2-hydroxy-1,1,1,3,3,3-hexafluoroisopropyl)-dichloromethylsilylbenzene and 4-(2-hydroxy-1,1,1,3,3,3-hexafluoroisopropyl)-dichloromethylsilylbenzene (with a GC area ratio of 1,2-subsituted isomer:1,3-substituted isomer:1,4-subsituted isomer=1:92:7) as obtained by Example 2 was charged into the flask. The mixture inside the flask was heated at 40° C. with stirring. The mixture was then subjected to alkoxylation by dropping 81.80 g (1400 mmol) of anhydrous ethanol at 1 mL/min through a dropping pump into the mixture while bubbling the mixture with nitrogen to remove hydrogen chloride. After dropping the whole amount of ethanol, the resulting reaction mixture was kept stirred for 30 minutes. Subsequently, excess ethanol was removed from the reaction mixture by means of a vacuum pump. By gas chromatographic measurement of the reaction mixture, the amount of unreacted chlorosilanes was determined. To the reaction mixture, 5.95 g (17.5 mmol) of a 20 mass % solidum ethoxide ethanol solution was added as a hydrogen halide scavenger. Herein, the amount of the solidum ethoxide ethanol solution added was 1.2 molar equivalent per mole of the chloro groups in the unreacted chlorosilanes. After the reaction mixture was further reacted for 30 minutes, excess ethanol was removed from the reaction mixture by means of a vacuum pump. The reaction mixture was simple-distilled, thereby obtaining 155.90 g of a mixture of 2-(2-hydroxy-1,1,1,3,3,3-hexafluoroisopropyl)-diethoxymethylsilylbenzene, 3-(2-hydroxy-1,1,1,3,3,3-hexafluoroisopropyl)-diethoxymethylsilylbenzene and 4-(2-hydroxy-1,1,1,3,3,3-hexafluoroisopropyl)-diethoxymethylsilylbenzene (GC area %: total of 1,2-, 1,3- and 1,4-substituted isomers=88.41% (1,2-substituted isomer=0.60%, 1,3-substituted isomer=83.50%, 1,4-substituted isomer=4.31%)) as a crude product. The yield of the crude product (i.e. the total yield through Examples 2 and 8) with reference to dichloromethylphenylsilane was 69%. By precision distillation of the crude product, 3-(2-hydroxy-1,1,1,3,3,3-hexafluoroisopropyl)-diethoxymethylsilylbenzene was obtained as a colorless transparent liquid (with a GC purity of 98%).

The ¹H-NMR and ¹⁹F-NMR measurement results of the obtained 3-(2-hydroxy-1,1,1,3,3,3-hexafluoroisopropyl)-diethoxymethylsilylbenzene are shown below. ¹H-NMR (solvent: CDCl₃, TMS): δ 7.96 (s, 1H), 7.76-7.73 (m, 2H), 7.47 (t, J=7.8 Hz, 1H), 3.86-3.75 (m, 6H), 3.49 (s, 1H), 1.23 (t, J=7.2 Hz, 6H), 0.37 (s, 3H) ¹⁹F-NMR (solvent: CDCl₃, CCl₃F): δ-75.96 (s, 6F)

### Example 9

### Second Step: Reaction of HFIP Group-Containing Aromatic Dichloromethylsilane and Ethanol using Triethyl Orthoformate as “Hydrogen Halide Scavenger”

Provided was a 300-mL four-neck flask with a thermometer, a mechanical stirrer and a Dimroth reflux tube. The inside of the flask was replaced with dry nitrogen. Then, 301.25 g of a mixture of 2-(2-hydroxy-1,1,1,3,3,3-hexafluoroisopropyl)-dichloromethylsilylbenzene, 3-(2-hydroxy-1,1,1,3,3,3-hexafluoroisopropyl)-dichloromethylsilylbenzene and 4-(2-hydroxy-1,1,1,3,3,3-hexafluoroisopropyl)-dichloromethylsilylbenzene (with a GC area ratio of 1,2-subsituted isomer:1,3-substituted isomer:1,4-subsituted isomer=1:92:7) as obtained by Example 2 was charged into the flask. The mixture inside the flask was heated at 40° C. with stirring. The mixture was then subjected to alkoxylation by dropping 100.60 g (2180 mmol) of anhydrous ethanol at 1.5 mL/min through a dropping pump into the mixture while bubbling the mixture with nitrogen to remove hydrogen chloride. After dropping the whole amount of ethanol, the resulting reaction mixture was kept stirred for 30 minutes. Subsequently, excess ethanol was removed from the reaction mixture by means of a vacuum pump. By gas chromatographic measurement of the reaction mixture, the amount of unreacted chlorosilanes was determined. To the reaction mixture, 6.30 g (42.5 mmol) of triethyl orthoformate was added as a hydrogen halide scavenger. Herein, the amount of the triethyl orthoformate added was 1.2 molar equivalent per mole of the chloro groups in the unreacted chlorosilanes. After the reaction mixture was further reacted for 30 minutes, excess ethanol was removed from the reaction mixture by means of a vacuum pump. The reaction mixture was simple-distilled, thereby obtaining 314.44 g of a mixture of 2-(2-hydroxy-1,1,1,3,3,3-hexafluoroisopropyl)-diethoxymethylsilylbenzene, 3-(2-hydroxy-1,1,1,3,3,3-hexafluoroisopropyl)-diethoxymethylsilylbenzene and 4-(2-hydroxy-1,1,1,3,3,3-hexafluoroisopropyl)-diethoxymethylsilylbenzene (GC area %: total of 1,2-, 1,3- and 1,4-substituted isomers=84.60% (1,2-substituted isomer=0.20%, 1,3-substituted isomer=78.17%, 1,4-substituted isomer=6.23%)) as a crude product. The yield of the crude product (i.e. the total yield through Examples 2 and 9) with reference to dichloromethylphenylsilane was 84%. By precision distillation of the crude product, 3-(2-hydroxy-1,1,1,3,3,3-hexafluoroisopropyl)-diethoxymethylsilylbenzene was obtained as a colorless transparent liquid (with a GC purity of 98%).

### Comparative Example 1

Into a 100-mL autoclave, 5.95 g (30.0 mmol) of trimethoxyphenylsilane and 0.40 g (3.0 mmol) of aluminum chloride were placed. The inside of the autoclave was replaced with nitrogen, followed by introducing 4.98 g (30 mmol) of HFA into the autoclave at room temperature. The resulting reaction mixture was kept stirred for 3 hours. However, a compound in which HFA was inserted in a silicon-alkoxy bond was formed as a main product of the reaction. The target alkoxysilane compound was not at all formed during the reaction.

### Comparative Example 2

Into a 100-mL autoclave, 7.21 g (30.0 mmol) of triethoxyphenylsilane and 0.40 g (3.0 mmol) of aluminum chloride were placed. The inside of the autoclave was replaced with nitrogen, followed by introducing 4.98 g (30 mmol) of HFA into the autoclave at room temperature. The resulting reaction mixture was kept stirred for 3 hours. However, a compound in which HFA was inserted in a silicon-alkoxy bond was formed as a main product of the reaction. The target alkoxysilane compound was not at all formed during the reaction.

### Comparative Example 3

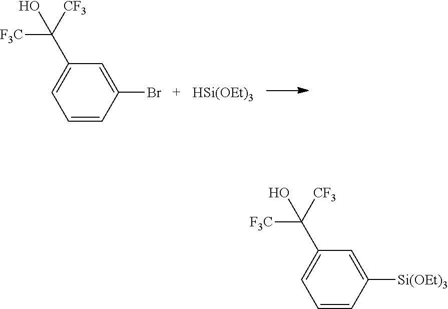

By a method disclosed in Japanese Laid-Open Patent Publication No. 2014-156461, 3-(2-hydroxy-1,1,1,3,3,3-hexafluoroisopropyl)-triethoxysilylbenzene was synthesized. More specifically, 6.46 g (20.0 mmol) of previously dried 3-(2-hydroxy-1,1,1,3,3,3-hexafluoroisopropyl)-bromobenzene, 7.38 g (40.0 mmol) of tetrabutylammonium iodide and 0.228 g (0.60 mmol) of bis(acetonitrile)(1,5-cyclooctadiene)rhodium (I) tetrafluoroborate were charged into a 300-mL three-neck flask with a reflux tube, followed by introduced thereinto 120 mL of dehydrated N,N-dimethylformamide, 11.1 mL (80.0 mmol) of dehydrated triethylamine and 7.40 mL (40.0 mmol) of triethoxysilane under an argon atmosphere. The resulting reaction mixture was heated to 80° C. and stirred for 4 hours. After the reaction system was naturally cooled to room temperature, the N,N-dimethylformamide solvent was removed from the reaction mixture. Subsequently, 200 mL of diisopropyl ether was added to the reaction mixture. The thus-formed precipitate was filtrated out by contact with cerite. The filtrate was washed three times with 100 mL of water and dehydrated with the addition of Na₂SO₄. The solvent was then removed from the filtrate. As a result, there was obtained 4.75 g of a brown liquid containing 3-(2-hydroxy-1,1,1,3,3,3-hexafluoroisopropyl)-triethoxysilylbenzene (GC area %=46.89%). The yield of the target compound with reference to 3-(2-hydroxy-1,1,1,3,3,3-hexafluoroisopropyl)-bromobenzene was 58%. It is assumed that the reaction efficiency became low (see the following TABLE 2) due to the occurrence of side reactions such as condensation reaction between ethoxysilane and hydrosilane (Si-OEt+Si—H→Si—O—Si+EtOH), reduction reaction of bromo group (bromo group→hydrogen group), hydrolysis during the washing with water, and the like.

The production results of the silicon compounds of the formula (4) (in the present specification, also referred to as HFIP group-containing aromatic alkoxysilanes) in Examples 4 to 7 and Comparative Examples 1 to 3 are shown in TABLE 2.

TABLE 2

| | Silicon compound of formula (4) | | |
|---|---|---|---|
| | GC area (%) | Yield (%) | Reaction efficiency *⁾ |
| Ex. 4 | 96.83 | 74 | 71.65 |
| Ex. 5 | 91.96 | 82 | 75.40 |
| Ex. 6 | 95.26 | 75 | 71.44 |
| Ex. 7 | 95.50 | 83 | 79.27 |
| Ex. 8 | 88.41 | 69 | 61.00 |
| Ex. 9 | 84.60 | 84 | 71.06 |
| Comp. Ex. 1 | 0 | 0 | 0 |
| Comp. Ex. 2 | 0 | 0 | 0 |
| Comp. Ex. 3 | 46.89 | 58 | 27.19 |

*⁾ Reaction efficiency = (GC area (%) × Yield (%))/100

In the table, the “yield” refers to an apparent yield assuming the purity of the material recovered by, after the completion of the reaction of the second step, removing the solvent etc. from the reaction mixture, or removing the solvent etc. from the reaction mixture and then distilling the reaction mixture, as 100%. (As to the yield of Example 4, the “total yield through Examples 1 and 4” is shown. Similarly, the total yield through Examples 1 and 5 is shown for Example 5; the total yield through Examples 1 and 6 is shown for Example 6; the total yield through Examples 1 and 7 is shown for Example 7; the total yield through Examples 2 and 8 is shown for Example 8; and the total yield through Example 2 and 9 is shown for Example 9.) The “reaction efficiency” refers to a value of multiplication of the “yield” by the purity of the residue.

As shown in TABLE 2, the target silicon compound of the formula (4) was obtained with a significantly high reaction efficient in Examples 1 to 7 where the production method according to the present invention was implemented, as compared to Comparative Example 3 where the target silicon compound was synthesized from the HFIP group-containing aromatic halogen compound (B), i.e., 3-(2-hydroxy-1,1,1,3,3,3-hexafluoroisopropyl)-bromobenzene. The advantageous effects of the present invention have thus been verified by these results. In Comparative Examples 1 and 2 each using the alkoxysilane as the raw material, by contrast, the compound in which HFA was inserted in the silicon-alkoxy bond was formed as the main product; and the target silicon compound of the formula (4) were not obtained.

### Example 10

### Third Step: Production of HFIP Group-Containing Polysiloxane Polymer Using HFIP Group-Containing Aromatic Alkoxysilane as Raw Material

In a 50-mL flask, 7.29 g (20 mmol) of the 3-(2-hydroxy-1,1,1,3,3,3-hexafluoroisopropyl)-trimethoxysilylbenzene obtained in precision-distilled form by Example 4, 1.08 g (60 mmol) of water and 0.06 g (1 mmol) of acetic acid were placed. The resulting reaction mixture was stirred at 100° C. for 24 hours. After the completion of the reaction, toluene was added to the reaction mixture. The reaction mixture was then refluxed by a Dean-Stark device (bath temperature: 150° C.) to remove the water, by-produced ethanol and acetic acid. Subsequently, the toluene was removed from the reaction mixture by means of a rotary evaporator and pump. As a result, there was obtained 5.96 g of a HFIP group-containing polysiloxane polymer with a repeating unit of the following formula (12) as a white solid. It was confirmed by GPC measurement that the HFIP group-containing polysiloxane polymer had a molecular weight of Mw=1970.

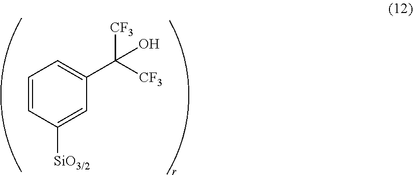

In the above formula, r represents an arbitrary integer.

### Example 11

### Third Step

In a 50-mL flask, 8.1 g (20 mmol) of the 3-(2-hydroxy-1,1,1,3,3,3-hexafluoroisopropyl)-triethoxysilylbenzene obtained in precision-distilled form by Example 6, 1.08 g (60 mmol) of water and 0.06 g (1 mmol) of acetic acid were placed. The resulting reaction mixture was stirred at 100° C. for 24 hours. After the completion of the reaction, toluene was added to the reaction mixture. The reaction mixture was then refluxed by a Dean-Stark device (bath temperature: 150° C.) to remove the water, by-produced ethanol and acetic acid. Subsequently, the toluene was removed from the reaction mixture by means of a rotary evaporator and pump. As a result, there was obtained 6.15 g of a HFIP group-containing polysiloxane polymer with a repeating unit of the above formula (12) as a white solid. It was confirmed by GPC measurement that the HFIP group-containing polysiloxane polymer had a molecular weight of Mw=1650.

### Example 12

### Third Step

In a 50-mL flask, 4.06 g (10 mmol) of the 3-(2-hydroxy-1,1,1,3,3,3-hexafluoroisopropyl)-triethoxysilylbenzene obtained in precision-distilled form by Example 6, 2.40 g (10 mmol) of phenyltriethoxysilane, 1.08 g (60 mmol) of water and 0.06 g (1 mmol) of acetic acid were placed. The resulting reaction mixture was stirred at 100° C. for 24 hours. After the completion of the reaction, toluene was added to the reaction mixture. The reaction mixture was then refluxed by a Dean-Stark device (bath temperature: 150° C.) to remove the water, by-produced ethanol and acetic acid. Subsequently, the toluene was removed from the reaction mixture by means of a rotary evaporator and pump. As a result, there was obtained 3.92 g of a HFIP group-containing polysiloxane polymer with a repeating unit of the following formula (13) as a white solid. It was confirmed by GPC measurement that the HFIP group-containing polysiloxane polymer had a molecular weight of Mw=2100.

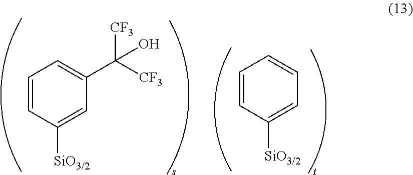

In the above formula, s and t represent a molar ratio with the proviso that s/t=50/50.

### Example 13

### Third Step

In a 50-mL flask, 7.5 g (20 mmol) of the 3-(2-hydroxy-1,1,1,3,3,3-hexafluoroisopropyl)-diethoxymethylsilylbenzene obtained in precision-distilled form by Example 7, 0.72 g (40 mmol) of water and 0.06 g (1 mmol) of acetic acid were placed. The resulting reaction mixture was stirred at 100° C. for 24 hours. After the completion of the reaction, toluene was added to the reaction mixture. The reaction mixture was then refluxed by a Dean-Stark device (bath temperature: 150° C.) to remove the water, by-produced ethanol and acetic acid. Subsequently, the toluene was removed from the reaction mixture by means of a rotary evaporator and pump. As a result, there was obtained 5.94 g of a HFIP group-containing polysiloxane polymer with a repeating unit of the following formula (14) as a colorless transparent liquid. It was confirmed by GPC measurement that the HFIP group-containing polysiloxane polymer had a molecular weight of Mw=1323.

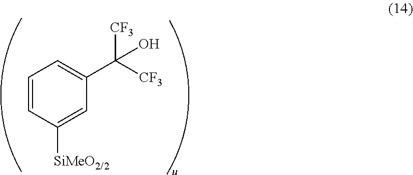

In the above formula, u represents an arbitrary integer.

### Example 14

### Fourth Step: Production of HFIP Group-Containing Polysiloxane Polymer Using HFIP Group-Containing Aromatic Chlorosilane as Raw Material

In a 50-mL flask, 7.6 g (20 mmol) of the 3-(2-hydroxy-1,1,1,3,3,3-hexafluoroisopropyl)-trichlorosilylbenzene obtained in precision-distilled form by Example 1 was placed. While the flask was cooled in an ice bath, 1.08 g (60 mmol) of water was dropped into the flask. The resulting reaction mixture was stirred for 1 hour at room temperature. After the completion of the reaction, remaining water and hydrogen chloride were removed from the reaction mixture by means of a pump.

As a result, there was obtained 5.13 f of a HFIP group-containing polysiloxane polymer with a repeating unit of the above formula (12) as a white solid. It was confirmed by GPC measurement that the HFIP group-containing polysiloxane polymer had a molecular weight of Mw=5151.

### INDUSTRIAL APPLICABILITY

Both of the HFIP group-containing aromatic halosilane (2) and the HFIP group-containing aromatic alkoxysilane (4) according to the present invention are useful as not only raw materials for synthesis of polymer resins, but also modifiers for polymers, surface treatment agents for inorganic compounds, coupling agents for various materials, intermediate raw materials for organic synthesis etc. Further, the HFIP group-containing polysiloxane polymer and films obtained therefrom are applicable as protective films for semiconductors, protective films for organic EL devices and liquid crystal displays, coating materials, flattening materials and microlens materials for image sensors, insulating protective films for touch panels, flattening materials for TFT liquid crystal displays, materials for forming cores and dads of optical waveguides, intermediate layers for multilayer resists, undercoating layers, antireflective films etc. because of their solubility in alkaline developers, patterning performance, high heat resistance and high transparency. The HFIP group-containing polysiloxoane polymer and films obtained therefrom, when applied to optical members of displays, image sensors etc., may be mixed with inorganic fine particles such as silicon oxide, titanium oxide, zirconium oxide etc. at any arbitrary ratio for the purpose of refractive index adjustment.

1. A silicon compound of the formula (2) 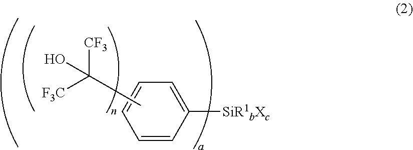
where R¹ is each independently a C₁-C₁₀ linear or C₃-C₁₀ branched or cyclic alkyl group, or a C₂-C₁₀ linear or C₃-C₁₀ branched or cyclic alkenyl group; a part or all of hydrogen atoms of the alkyl group or alkenyl group as R¹ may be substituted with a fluorine atom; X is a halogen atom; a is an integer of 1 to 3; b is an integer of 0 to 2; c is an integer of 1 to 3; a relationship of a+b+c=4 is satisfied; and n is an integer of 1 to 5.

2. The silicon compound according to claim 1, wherein the following group (2_{HFIP}) in the formula (2) is any of those represented by the formulas (2A) to (2D) 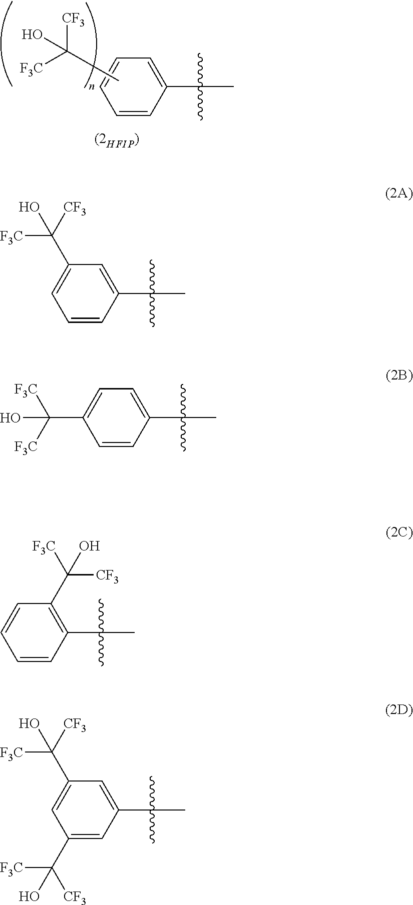
where each wavy line represents that a line which the wavy line intersects is a bond.

3. The silicon compound according to claim 1, wherein X is a chlorine atom.

4. The silicon compound according to claim 1, wherein b is 0 or 1.

5. The silicon compound according to claim 1, wherein R¹ is a methyl group.

6. A production method of a silicon compound of the formula (2), comprising the following step:
a first step of reacting an aromatic silicon compound of the formula (1) with hexafluoroacetone in the presence of a Lewis acid catalyst, thereby obtaining the silicon compound of the formula (2) 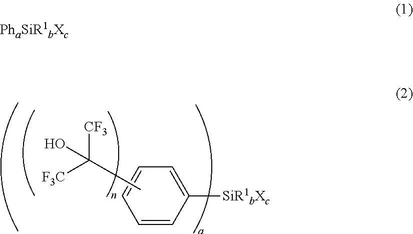
where Ph is an unsubstituted phenyl group; R¹ is each independently a C₁-C₁₀ linear, C₃-C₁₀ branched or C₃-C₁₀ cyclic alkyl group, or a C₂-C₁₀ linear, C₃-C₁₀ branched or C₃-C₁₀ cyclic alkenyl group; a part or all of hydrogen atoms of the alkyl group or alkenyl group as R¹ may be substituted with a fluorine atom; X is a halogen atom; a is an integer of 1 to 3; b is an integer of 0 to 2; c is an integer of 1 to 3; a relationship of a+b+c=4 is satisfied; and n is an integer of 1 to 5.

7. A production method of a silicon compound of the formula (4), comprising the following steps:
a first step of reacting an aromatic silicon compound of the formula (1) with hexafluoroacetone in the presence of a Lewis acid catalyst, thereby obtaining a silicon compound of the formula (2); and
a second step of forming the silicon compound of the formula (4) by reacting the silicon compound of the formula (2) obtained in the first step with an alcohol of the formula (3) 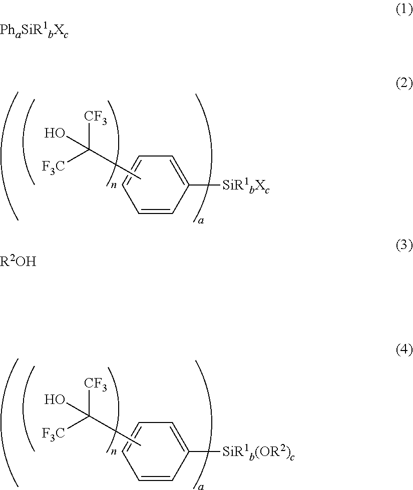
where Ph is an unsubstituted phenyl group; R¹ is each independently a C₁-C₁₀ linear, C₃-C₁₀ branched or C₃-C₁₀ cyclic alkyl group, or a C₂-C₁₀ linear, C₃-C₁₀ branched or C₃-C₁₀ cyclic alkenyl group; a part or all of hydrogen atoms of the alkyl group or alkenyl group as R¹ may be substituted with a fluorine atom; X is a halogen atom; a is an integer of 1 to 3; b is an integer of 0 to 2; c is an integer of 1 to 3; a relationship of a+b+c=4 is satisfied; n is an integer of 1 to 5; R² is each independently a C₁-C₄ linear or C₃-C₄ branched alkyl group; and a part or all of hydrogen atoms of the alkyl group as R² may be substituted with a fluorine atom.

8. The production method according to claim 7, wherein the following group (2_{HFIP}) in the formulas (2) and (4) is any of those represented by the formulas (2A) to (2D) 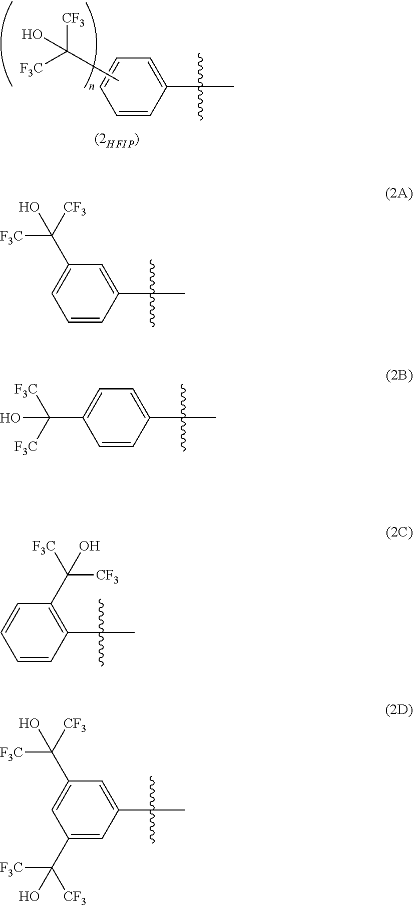
where each wavy line represents that a line which the wavy line intersects is a bond.

9. The production method according to claim 7, wherein X is a chlorine atom.

10. The production method according to claim 7, wherein R² is a methyl group or an ethyl group.

11. The production method according to claim 7, wherein b is 0 or 1.

12. The production method according to claim 7, wherein R¹ is a methyl group.

13. The production method according to claim 7, wherein the Lewis acid catalyst used in the first step is selected from the group consisting of aluminum chloride, iron (III) chloride and boron trifluoride.

14. The production method according to claim 7,
wherein X is a chlorine atom,
wherein R² is a methyl group or an ethyl group,
wherein b is 0 or 1, and
wherein the Lewis acid catalyst used in the first step is selected from the group consisting of aluminum chloride, iron (III) chloride and boron trifluoride.

15. The production method according to claim 7, wherein, in the second step, the reacting is performed with the addition of a hydrogen halide scavenger.

16. The production method according to claim 15, wherein the hydrogen halide scavenger is selected from the group consisting of orthoesters and sodium alkoxides.

17. A production method of a silicon compound of the formula (4), comprising the following step:
a second step of reacting a silicon compound of the formula (2) with an alcohol of the formula (3), thereby forming the silicon compound of the formula (4) 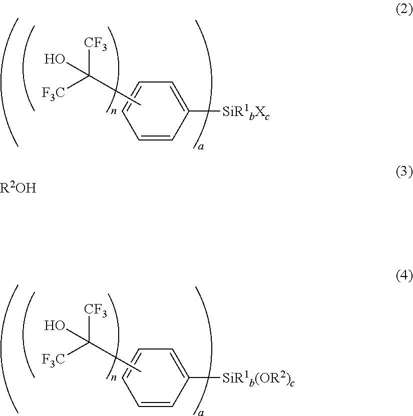
where R¹ is each independently a C₁-C₁₀ linear, C₃-C₁₀ branched or C₃-C₁₀ cyclic alkyl group, or a C₂-C₁₀ linear, C₃-C₁₀ branched or C₃-C₁₀ cyclic alkenyl group; a part or all of hydrogen atoms of the alkyl group or alkenyl group as R¹ may be substituted with a fluorine atom; X is a halogen atom; a is an integer of 1 to 3; b is an integer of 0 to 2; c is an integer of 1 to 3; a relationship of a+b+c=4 is satisfied; n is an integer of 1 to 5; R² is each independently a C₁-C₄ linear or C₃-C₄ branched alkyl group; and a part or all of hydrogen atoms of the alkyl group as R² may be substituted with a fluorine atom.

18. The production method according to claim 17, wherein, in the second step, the reacting is performed with the addition of a hydrogen halide scavenger.

19. The production method according to claim 18, wherein the hydrogen halide scavenger is selected from the group consisting of orthoesters and sodium alkoxides.

20. A production method of a polysiloxane polymer (A) with a repeating unit of the formula (5), comprising the following step after forming the silicon compound of the formula (4) by the production method according to claim 7:
a third step of subjecting the silicon compound of the formula (4) to hydrolysis and polycondensation, thereby obtaining the polysiloxane polymer (A) 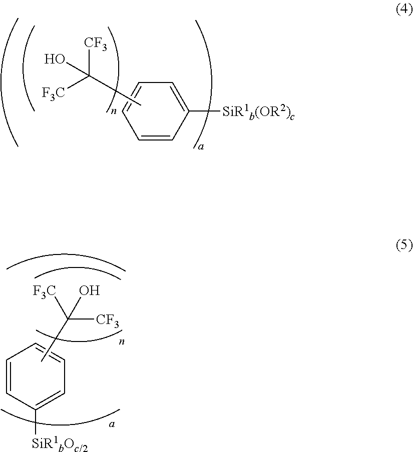
where R¹ is each independently a C₁-C₁₀ linear, C₃-C₁₀ branched or C₃-C₁₀ cyclic alkyl group, or a C₂-C₁₀ linear, C₃-C₁₀ branched or C₃-C₁₀ cyclic alkenyl group; a part or all of hydrogen atoms of the alkyl group or alkenyl group as R¹ may be substituted with a fluorine atom; a is an integer of 1 to 3; b is an integer of 0 to 2; c is an integer of 1 to 3; a relationship of a+b+c=4 is satisfied; n is an integer of 1 to 5; R² is each independently a C₁-C₄ linear or C₃-C₄ branched alkyl group; and a part or all of hydrogen atoms of the alkyl group as R² may be substituted with a fluorine atom.

21. A production method of a polysiloxane polymer (A) with a repeating unit of the formula (5), comprising the following step:
a fourth step of subjecting a silicon compound of the formula [2] to hydrolysis and polycondensation, thereby obtaining the polysiloxane polymer (A) 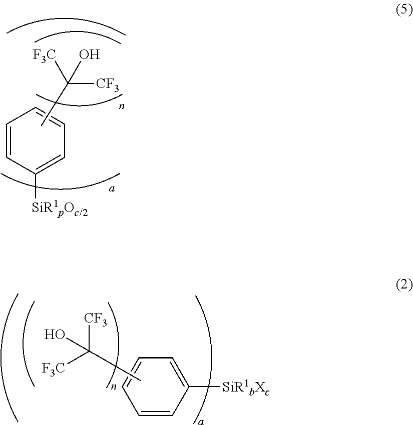
where R¹ is each independently a C₁-C₁₀ linear, C₃-C₁₀ branched or C₃-C₁₀ cyclic alkyl group, or a C₂-C₁₀ linear, C₃-C₁₀ branched or C₃-C₁₀ cyclic alkenyl group; a part or all of hydrogen atoms of the alkyl group or alkenyl group as R¹ may be substituted with a fluorine atom; X is a halogen atom; a is an integer of 1 to 3; b is an integer of 0 to 2; c is an integer of 1 to 3; a relationship of a+b+c=4 is satisfied; n is an integer of 1 to 5; R² is each independently a C₁-C₄ linear or C₃-C₄ branched alkyl group; and a part or all of hydrogen atoms of the alkyl group as R² may be substituted with a fluorine atom.
